(19) United States
(12) Patent Application Publication
(10) Pub. No.: US 2023/0191357 A1
(43) Pub. Date: Jun. 22, 2023

(54) SYSTEM AND METHOD FOR ENHANCING THE REACTION POTENTIAL OF PRODUCTS GENERATED FROM IONIZATION, PHOTON-ENHANCED THERMIONIC EMISSION, MULTI PHOTON ABSORPTION, PHOTOOXIDATION, PHOTOCATALYTIC, AND PHOTOCHEMICAL REACTIONS WITH OXIDIZING AGENTS

(71) Applicant: Bis Science LLC, Fort Worth, TX (US)

(72) Inventors: Marc W. GUNDERSON, Fort Worth, TX (US); Paul DABNEY, Georgetown, TX (US)

(73) Assignee: Bis Science LLC, Fort Worth, TX (US)

(21) Appl. No.: 17/973,861

(22) Filed: Oct. 26, 2022

Related U.S. Application Data
(60) Provisional application No. 63/290,833, filed on Dec. 17, 2021.

(51) Int. Cl. B01J 19/12

(52) U.S. Cl. CPC B01J 19/12; B01J 19/121; B01J 19/125; B01J 2219/12

(57) ABSTRACT

Methods and systems for enhancing the effectiveness of products generated from ionization, photon-enhanced thermionic emission, multi photon absorption, photo-oxidation, photocatalytic, and/or photochemical reactions utilize an oxidizing agent and photon emissions at wavelengths in a range from 0.01 nm to 845 nm, wherein wavelengths that photo-dissociate trioxygen are excluded.

### BACKGROUND

The photon is a type of elementary particle. It is the quantum of the electromagnetic field including electromagnetic radiation such as gamma rays, x-rays, light and radio waves, and the force carrier for electromagnetic force. A photon is the smallest discrete amount or quantum of electromagnetic radiation. It is the basic unit of all light. Photons are massless, so they always move at the speed of light in vacuum, 299,792,458 m/s (or about 186,282 mi/s). Like all elementary particles, photons are currently best explained by quantum mechanics and exhibit wave-particle duality, their behavior featuring properties of both waves and particles. Biophotons are photons that are produced or utilized by a biological system. They are non-thermal in origin, and the emission of biophotons is technically a type of bioluminescence,

When a photon reacts with a material, it is absorbed or reflected or scattered by the material. The material then may generate an internal electromagnetic vibration that is not precisely a “photon” -it’s called a “phonon”. The phonon has a less-than-light velocity that depends on the properties of the material. A phonon is a definite discrete unit or quantum of vibrational mechanical energy, just as a photon is a quantum of electromagnetic energy. At each frequency, quantum mechanic’s principles dictate that the vibrational energy must be a multiple of a basic amount of energy, called a quantum, that is proportional to the frequency. Physicists call these basic levels of energy phonons. In a sense, “phonon” is a word to represent a particle of heat.

Photon-enhanced thermionic emission (PETE) combines the quantum and thermal processes obtained from a reaction into a single physical process to take simultaneous advantage of photons and of the available thermal energy of the generated phonons. Thermionic emission is the liberation of electrons by virtue of its temperature. Releasing of energy supplied by phonons. This occurs because the thermal energy given to the charge carrier overcomes the work function of the material.

The charge carriers can be electrons or ions. Charge carriers are particles or holes that freely move within a material and carry an electric charge. In most electric circuits and electric devices, the charge carriers are negatively charged electrons that move under the influence of a voltage to create an electric current. However, most circuitry is designed in terms of conventional current, which uses positive charges that move in the opposite direction of electrons. Other than electrons and positively charged particles, holes are also charge carriers. Holes are empty valence electron orbitals, and as such, they represent an electron deficiency that can move freely within a material.

There are two basic types of atomic motion in a liquid: phonon motion and diffusional motion due to an atom jumping between two equilibrium positions. In turn, phonon motion and diffusional motion include kinetic and potential parts, giving the substance energy as

$$E = {K}_{l} + {P}_{l} + {K}_{s} \left(ω > {ω}_{\text{F}}\right) + {P}_{s} \left(ω > {ω}_{\text{F}}\right) + {K}_{d} + {P}_{d}$$

where K₁ and P₁ are kinetic and potential components of the longitudinal phonon energy, Kₛ(ω > ω_{F}) and Pₛ(ω > ω_{F}) are kinetic and potential components of the energy of shear phonons with frequency ω > ω_{F}, and K_{d} and P_{d} are kinetic and potential energy of diffusing atoms. Diffusion is the net movement of anything (for example, atoms, ions, molecules, energy) from a region of higher concentration to a region of lower concentration. Diffusion is driven by a gradient in concentration. Phonon motion (heat motion) and diffusional motion work together so that temperature and composition are the same throughout a liquid.

In practice, most materials are filled with an ever-changing mix of phonons that have different frequencies and are traveling in different directions, all superimposed on each other, in the same way that the seemingly chaotic movements of a choppy sea can (theoretically) be untangled to reveal a variety of superimposed waveforms of different frequencies and directions. But unlike photons, which generally don’t interact if they have different wavelengths, phonons of different wavelengths can interact and mix when they collide into each other, producing a different wavelength. This makes their behavior much more chaotic and thus difficult to predict and control.

Electromagnetic radiation photons can interact among themselves and with matter, giving rise to a multitude of phenomena such as reflection, refraction, scattering, polarization, diffraction, and others. X-ray diffraction is the physical phenomenon that expresses the fundamental interaction between x-rays and ordered matter. To describe the phenomenon, this disclosure will introduce some physical models that help explain the interaction of photons and matter. These can be used to help understand the phenomenon.

An electromagnetic wave is an undulatory phenomenon that propagates through space and time and is regularly repeated. (FIG. 1). Waves propagate at a certain speed and can be modeled to meet a wave equation, scalar or vectorial, depending on the nature of the disturbance. A wave is a regular phenomenon as it repeats exactly in time and space. The frequency is the number of repetitions (or cycles) per unit of time. X-ray waves interact with matter through the electrons contained in atoms, which are moving at speeds much slower than light. When the electromagnetic radiation reaches an electron, it becomes a secondary source of electromagnetic radiation that may scatter the incident radiation if there is sufficient energy. According to the wavelength and phase relationships of the scattered radiation, we can refer to elastic processes or inelastic processes (Compton scattering), depending on if the wavelength does not change (or changes). The exchanges of energy and momentum that are produced during these processes can even lead to the expulsion of an electron out of the atom, followed by the occupation of its energy level by electrons located in higher energy levels. All these types of interactions lead to different processes in the materials such as: refraction, absorption, fluorescence, scattering, Compton scattering, polarization, diffraction, reflection, and others.

The refractive index of all materials in relation to X-rays is close to 1, so that the phenomenon of refraction of X-rays is negligible. This explains why it is not possible to produce lenses for X-rays. It does not explain why reflective optics (catoptric system) cannot be used. The present disclosure makes use of the reflective and scattering of photons and x-ray photons. As used herein, photon absorption means an attenuation of the transmitted beam, losing its energy through all types of interactions, mainly thermal (phonons, PETE), fluorescence, inelastic scattering, formation of free radicals and other chemical modifications that could lead to degradation of the material. This intensity decrease follows an exponential model dependent on the distance crossed and on a coefficient of the material (the linear absorption coefficient) which depends on the density and composition of the material.

The process of fluorescence, in which an electron is pulled out of an atom’s energy level, provides information on the chemical composition of the material due to the expulsion of electrons from the different energy levels. In the Compton effect, the interaction is inelastic and the electromagnetic radiation loses energy. This phenomenon is always present in the interaction of x-rays with matter, By scattering, this disclosure refers to the changes of direction suffered by the incident radiation.

FIG. 2 illustrates the interaction of a x-ray with an isolated electron, which if the energy is sufficient becomes a new endogenous x-ray source, producing the x-ray waves in a spherical mode. When a x-ray interacts with an electron, the interaction takes place primarily through its electric field. In a first approximation, we can neglect both the magnetic and nuclear interactions. According to the electromagnetic theory of Maxwell, the electron scatters electric waves which propagate perpendicular to the electric field.

An atom can be considered as a set of electrons (its atomic number). The distances between the electrons of an atom are of the order of the x-rays wavelength, and therefore we can also expect some type of partial destructive interferences among the scattered waves. In fact, an atom scatters in the direction of the incident beam, decreasing with the increasing of the angle between the incident radiation and the direction where we measure the scattering. And the more diffuse the electronic distribution of electrons around the nucleus, the greater the reduction. X-rays scattered by an atom produce x-ray radiation in all directions, leading to interferences due to the coherent phase differences between the interatomic vectors that describe the relative position of atoms. In a molecule or in an aggregate of atoms, this effect is known as the effect of internal interference, while we refer to an external interference as the effect that occurs between molecules or aggregates.

No matter the possible complexity with which the phenomenon of x-ray scattering is presented, there are a few general considerations. X-rays are scattered by electrons contained in atoms. This dispersion effect (which is produced in the form of waves, scattered in all directions of space) contains different intensities (amplitudes) depending on the number of electrons (electron density) contributing to the scattered waves. The total scattered wave in each direction is equal to the sum of all the individual waves which scatter in the same direction. Its intensity (amplitude) will be governed by the phase relationship between the contributing waves, which depends on the distance between the points where they originate. This will happen for all space directions.

Photoexcitation is the production of an excited state of a quantum system by photon absorption. The excited state originates from the interaction between a photon and the quantum system. On the atomic and molecular scale, photoexcitation is the photoelectrochemical process of electron excitation by photon absorption when the energy of the photon is too low to cause photoionization.

Ionization is adding or removing electrons from an atom or molecule, so the atom or molecule now has a positive or negative charge. The ionization energy can be viewed as the energy required to remove an electron from its orbital around an atom to a point where it is no longer associated with that atom (FIG. 3). In this disclosure, ionization energy in the form of photons and phonons is applied to an oxidizing agent. This ionization energy removes an electron from the target (oxidizing agent and/or water) which in some instances creates a hydron (a positively charged hydrogen ion,also called a hydrogen proton). A hydron is the general name for a cationic form of atomic hydrogen, represented with the symbol H+. It refers collectively to protons (1H+) for the protium isotope, deuterons (2H+ or D+) for the deuterium isotope, and tritons (3H+ or T+) for the tritium isotope. Unlike most other ions, the hydron consists only of a bare atomic nucleus. The negatively charged counterpart of the hydron is the hydride anion, H-.

The ionization energy may also be defined as the minimum energy required to remove an electron from an isolated atom, ion, or a molecule. Due to its extremely high charge density, the bare hydrogen ion cannot exist freely in solution as it readily bonds quickly. The ionization of water is an ionization reaction in water or in an aqueous solution containing water, in which a water molecule, H₂O, deprotonates (loses the nucleus of one of its hydrogen atoms) to become a hydroxide ion, OH⁻. The hydrogen nucleus H⁺, immediately protonates another water molecule to form hydronium, H₃O⁺. The radiolysis of water due to ionizing radiation results in the production of electrons, oxygen and its ions, hydrogen and its ions, hydroxyl radicals, H₃O⁺ ions and molecules, hydron and hydrogen peroxide (FIG. 4).

This disclosure utilizes excitation, ionization and photon-enhanced thermionic emission of oxidizing agents and water to form a self-sustaining circuit of reactions that utilizes photon-enhanced thermionic emission (PETE) to ionize and/or increase energy states of atoms and/or molecules as well as ionization energy to provide free electrons and free protons.

In chemistry, molecular orbital theory (MOT) is a method for describing the electronic structure of molecules using quantum mechanics. The molecular orbital theory model is the most descriptive of the various models of chemical bonding and serves as the basis for most quantitative calculations. In its full development, molecular orbital theory involves complicated mathematics, but the fundamental ideas behind it are quite easily understood. Chemical bonding occurs when the net attractive forces between an electron and two nuclei exceeds the electrostatic repulsion between the two nuclei. For this to happen, the electron must be in a region of space called the binding region. Conversely, if the electron is off to one side, in an anti-binding region, it adds to the repulsion between the two nuclei and helps push them away.

Wave phenomena such as sound waves, electromagnetic waves, or even ocean waves can combine or interact with one another in two ways: they can either reinforce each other, resulting in a stronger wave, or they can interfere with and partially destroy each other. A roughly similar thing occurs when the “matter waves” corresponding to the two separate hydrogen 1 s orbitals interact; both in-phase and out-of-phase combinations are possible, and both occur. The in-phase, reinforcing interaction yields the bonding orbital that we just considered. The other, corresponding to out-of-phase combination of the two orbitals, gives rise to a molecular orbital that has its greatest electron probability in what is clearly the antibonding region of space. This second orbital is therefore called an antibonding orbital. FIG. 5 represents the hydrogen molecule ion, which contains two nuclei of charge +1, and a single electron shared between them.

As two H nuclei move toward each other, the 1 s atomic orbitals of the isolated atoms gradually merge into a new molecular orbital in which the greatest electron density falls between the two nuclei. Since this is just the location in which electrons can exert the most attractive force on the two nuclei simultaneously, this arrangement constitutes a bonding molecular orbital. In molecular orbital theory, electrons in a molecule are not assigned to individual chemical bonds between atoms but are treated as moving under the influence of the atomic nuclei in the whole molecule. Regarding it as a three- dimensional region of space, we see that it is symmetrical about the line of centers between the nuclei; in accord with our usual nomenclature, we refer to this as a σ (sigma) orbital. Since any hydrogen orbital can hold a maximum of two electrons, the bonding orbital in H2+ is only half-full. This single electron is nevertheless enough to lower the potential energy of one mole of hydrogen nuclei pairs by 270 kJ - enough to make them bond together and behave like a distinct molecular species.

Although H2+ is stable in this energetic sense, it happens to be an extremely reactive molecule. So much so that it even reacts with itself, so these ions are not commonly encountered in everyday chemistry. Molecular orbital theory suggests that chemical substances will form bonding interactions if their orbitals become lower in energy when they interact with each other. Different bonding orbitals are distinguished that differ by electron configuration (electron cloud shape) and by energy levels. In MOT, any electron in a molecule may be found anywhere in the molecule, since quantum conditions allow electrons to travel under the influence of an arbitrarily large number of nuclei.

When excited with the requisite amount of energy through photon-enhanced thermionic emission (PETE) to ionize and/or increase energy states, and/or when excited by ionization energy in the form of free electrons or free protons, electrons can transition to higher-energy molecular orbitals. For instance, in the simple case of a hydrogen diatomic molecule, promotion of a single electron from a bonding orbital to an antibonding orbital can occur under photon emissions of from 0.01 nm through 845 nm. This promotion weakens the bond between the two hydrogen atoms and can lead to photodissociation - the breaking of a chemical bond due to the absorption of photons. The present disclosure utilizes photon-enhanced thermionic emissions, ionization, oxidation, reduction and molecular orbital theory to describe the synergistic reactions that are disclosed herein.

As disclosed herein, oxidation may be viewed as a chemical process of charge transfer. Oxidation is loss of electrons. Reduction is gain of electrons. An oxidizing agent can also be termed as an electron acceptor because it accepts an electron. Oxidation is defined as a process in which an electron is removed from a molecule during a chemical reaction. During oxidation, there is a transfer of electrons. A high oxidation state chemical like H₂O₂ or a highly electronegative elements like O₂ are good examples of oxidizing agents (FIG. 6).

Photooxidation is a chain process of reactions incorporating a large number of chemical reactions that are subsequent to the outcome of the primary event, which in the present disclosure relates to an oxidizing agent absorption and/or water absorption of a photon. This may also include photon-enhanced thermionic emission. These reactions generate a photon augmented oxidizing agent(PAOA). This also induces breakdown of the oxidizing agent compound to free-radical products.

The present disclosure utilizes ionization (photons) and PETE energy as an initiator of photooxidation. Photon emissions with a wavelength in a range of from 0.01 nm to 845 nm (845 nm, the upper wavelength that photolyzes oxygen to oxygen bonds in hydrogen peroxide; 0.01 nm, the lower limit of x-ray photons) are directed at oxidizing agents creating free electrons. A photon is a form of electromagnetic radiation that is associated with energy. Some properties of photons include wavelength and frequency. Frequency (typically measured in Hertz) is the number of waves in a specific time. Wavelength (typically measured in nanometers) is the distance between two points in a wave. Just as wavelength and frequency are related to photons emissions, they are also related to energy associated with the photons. The shorter the wavelengths and higher the frequency corresponds with greater energy. So, the longer the wavelengths and lower the frequency results in lower energy.

Photons are often described as energy packets. These packets of energy can be transmitted over vast distances with no decay in energy or speed. As used herein, the frequency of a photon is defined as how many wavelengths a photon propagates each second. As a substance is heated, the atoms within the substance vibrate at higher energies. These vibrations may rapidly change the shape and energies of electron orbitals. As the energy of the electrons change, photons may be emitted and absorbed at energies corresponding to the energy of the change. Phonons are also associated with these energy changes. The free electrons generated with photons interacting with oxidizing agents can enhance the oxidation of atoms or molecules. When the photon emissions create free electrons by removing them from an atom or molecule, energy is released in the form of x-ray photons when a remaining electron in the atom or molecule moves into the recently vacated orbit of the freed electron. These generated x-ray photons can now be absorbed by other atoms or molecules.

Certain types of radioactive decay can involve the release of high energy photons. One such type of decay is a nuclear isomerization. In an isomerization, a nucleus rearranges itself to a more stable configuration and emits a gamma ray. Proton decay may also emit extremely high energy photons as gamma rays. By containing the reactions displayed in this disclosure in x-ray photon reflective and/or scattering containers or areas, x-ray photons are redirected so that more are available for this reaction. That will be further discussed in this disclosure and referred to as a self-sustaining circuit of reactions.

Multi-photon absorption (MPA) or multi-photon excitation or non-linear absorption is the simultaneous absorption of two or more photons of identical or different frequencies to excite a molecule from one state (usually the ground state) to a higher energy, most commonly an excited electronic state. MPA is one of a variety of multi-photon processes. In this specific process, two or more photons are absorbed by a sample simultaneously. Neither photon may be at resonance with the available energy states of the system, however, the combined frequency of the photons is at resonance with an energy state. In quantum mechanics, an excited state of a system is any quantum state of the system that has a higher energy than the ground state (that is, more energy than the absolute minimum). Absorption of two or more photons with different frequencies is called “non-degenerate” MPA. Since MPA depends on the simultaneous absorption of two or more photons, the probability of MPA is proportional to the square of the photon intensity, thus it is a nonlinear optical process. The energy difference between the involved lower and upper states of the molecule is equal or smaller than the sum of the photon energies of the two or more photons absorbed. MPA is a third-order process, with absorption cross section typically several orders of magnitude smaller than one-photon absorption cross section.

### SUMMARY

The present disclosure is directed to methods for enhancing the effectiveness of products generated from ionization reactions, photon-enhanced thermionic emission reactions, multi photon absorption reactions, photooxidation reactions, photocatalytic reactions, photochemical reactions, and/or a combination of these reactions. Various embodiments of the reactions contain one or more oxidizing agents, reactive nitrogen species, hydrogen and/or its isotopes, oxygen and/or its isotopes, electronically modified oxygen derivatives, reactive oxygen species, trioxygen, beta particles, hydrons, trioxidane, and other free radicals. Embodiments of the present disclosure utilize photons and phonons in methods to achieve photon augmented oxidizing agents (PAOA) that can be utilized to generate a self-sustaining circuit of reactions.

Various embodiments of the methods include steps of applying at least one oxidizing agent to a target, a substance, and/or an area to be treated, applying photon emissions at one or more wavelengths in a range from 0.01 nm through 845 nm to the oxidizing agent, the target, the substance, and/or area to be treated, wherein wavelengths that photo-dissociate trioxygen are excluded, and performing an oxidizing reaction between the at least one photon augmented oxidizing agent and the target, the substance, and/or the area to be treated, which produces ionization reaction products, photon-enhanced thermionic emission reaction products, multi photon absorption reaction products, photo-oxidation reaction products, photocatalytic reaction products, photochemical reaction products, and/or a combination of these reactions and their reaction products.

According to various embodiments, the resulting reactions occur wherein the ionization reaction products, photon-enhanced thermionic emission reaction products, multi photon absorption reaction products, photo-oxidation reaction products, photocatalytic reaction products, photochemical reaction products, and/or combination of these reactions and their reaction products generates at least one of trioxygen, hydrogen and its ions, oxygen and its ions, hydroxyl radical, reactive oxygen species (ROS), free radicals, x-ray photons, beta particles, hydrons, trioxidane, free electrons, and electronically modified oxygen derivatives.

The present disclosure is also directed to systems configured to perform a method for enhancing the effectiveness of products generated from ionization reactions, photo-enhanced thermionic emission reactions, multi-photon absorption reactions, photo-oxidation reactions, photocatalytic reactions, photochemical reactions, and/or a combination of these reactions. Various embodiments of the system include a reaction area, in which at least one oxidizing agent functions together with photon emissions of from 0.01 nm through 845 nm to perform an ionization reaction and/or an oxidation reaction so that products of the ionization reaction and/or the oxidation reaction can be collected and/or separated at any time during the reaction, at least one oxidizing agent introducing component for applying the at least one oxidizing agent to the target, the substance, and/or the area to be treated, and at least one photon emitting component for creating and dispensing the photon emissions. Various embodiments of the system are configured to perform the methods disclosed herein.

These and other aspects of the present disclosure will be better appreciated and understood when considered in conjunction with the following description and the accompanying drawings. The following description, while indicating various embodiments and numerous specific details thereof, is given by way of illustration and not of limitation. Many substitutions, modifications, additions, or rearrangements may be made within the scope of the embodiments, and the embodiments include all such substitutions, modifications, additions, or rearrangements.

Aspects of the present disclosure are disclosed in the following description and related drawings, diagrams, and pictures directed to specific embodiments. Alternate embodiments may be devised without departing from the spirit or the scope of the disclosure. Additionally, well-known elements of exemplary embodiments will not be described in detail or will be omitted so as not to obscure the relevant details of the disclosure.

### BRIEF DECRIPTION OF THE DRAWINGS

The patent or application file contains at least one drawing executed in color. Copies of this patent or patent application publication with color drawing(s) will be provided by the Office upon request and payment of the necessary fee.

Non-limiting and non-exhaustive embodiments of the disclosure are described with reference to the following figures and detailed description.

FIG. 1 is a diagram of an electromagnetic wave, showing amplitude and wavelength.

FIG. 2 is a diagram illustrating the interaction of an x-ray with an isolated electron.

FIG. 3 is a diagram illustrating ionization.

FIG. 4 is a diagram illustrating the effects of ionizing radiation on water (H₂O), and the resulting production of electrons, oxygen and its ions, hydrogen and its ions, hydroxyl radicals, hydronium ions, hydron, and hydrogen peroxide.

FIG. 5 is a diagram illustrating the hydrogen molecule ion, which has two nuclei of charge +1 and a single electron shared between them. As two H nuclei move toward each other, the 1 s atomic orbitals merge into a new molecular orbital in which the greatest electron density falls between the two nuclei.

FIG. 6 is a diagram illustrating oxidation in which Compound A loses electrons, and reduction in which Compound B gains electrons.

FIG. 7 is a photograph of pressure gauges connected to gas cannisters. The canister on the left contains H₂O₂ exposed to photon emissions from 0.01 nm - 845 nm according to an embodiment of the disclosure. The canister on the right contains H₂O₂ that was not exposed to photon emissions. The photo was taken 48 hours after photon exposure.

FIG. 8A is photograph of a hydrogen detection meter with the detection probe directed at the opening in the photon activation chamber. The photon activation chamber is OFF so the reading on the meter is ZERO ppm. FIG. 8B is a photograph of a hydrogen detection meter with the detection probe directed at the opening in the photon activation chamber. The photon activation chamber is ON and the reading on the meter shows the generated hydrogen from reactions displayed by embodiments of the disclosure.

FIG. 9 is a diagram illustrating the Lewis structure and O—O bond energy of O₂, O₃, and HOOH.

FIG. 10 is a diagram illustrating that photon/phonon exposure generates additional photons and phonons (including x-ray photons). The x-ray photons generated in the reaction generate additional reactants when the oxidizing agent is re-ionized by the photons created in the reaction target.

FIG. 11 is a diagram illustrating common H₂O₂ redox products.

FIG. 12A is a photo of a Geiger Counter count from hydrogen peroxide (H₂O₂) that has not been exposed to photons or phonons. FIG. 2B is a photo of a Geiger Counter count from hydrogen peroxide (H₂O₂) that has been exposed to photons in a range from 0.01 nm - 845 nm as described by an embodiment of the methods in the present disclosure.

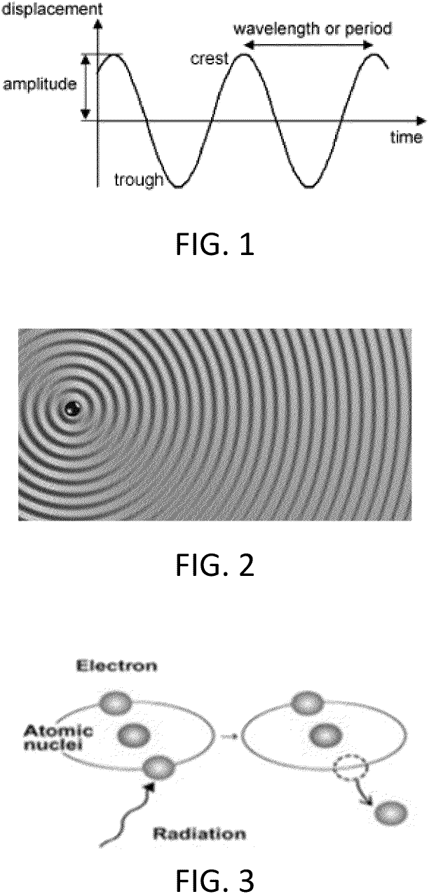

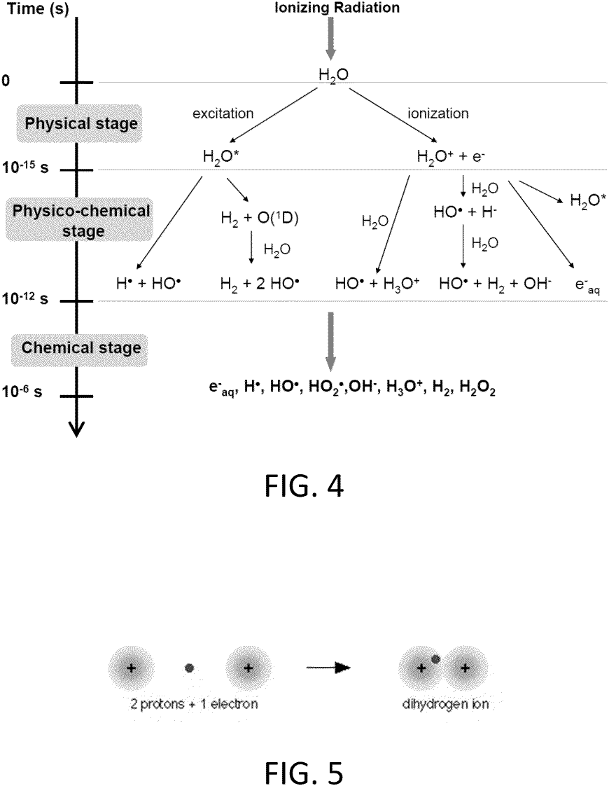

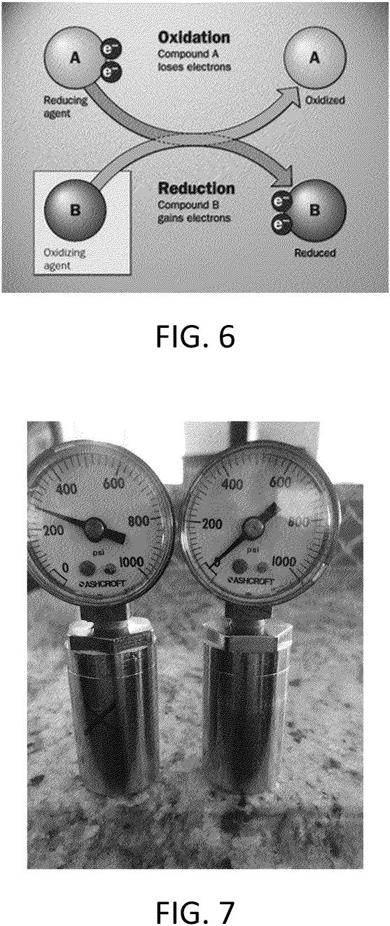

### DETAILED DESCRIPTION

According to various embodiments the described methods and systems produce Photon Augmented Oxidizing Agents (PAOAs). These PAOAs contain more Electronically Modified Oxygen Derivatives (EMODs) then oxidizing agents that have not been exposed to photon emissions where the photon wavelengths are 0.01 nm up to and including 845 nm (845 nm, the upper wavelength that photolyzes oxygen to oxygen bonds in hydrogen peroxide; 0.01 nm, the lower limit of x-ray photons). Various embodiments produce PAOAs that generate oxygen (and it’s derivatives) and hydrogen (and it’s derivatives) as well as Reactive Oxygen Species (ROS) and EMODs.

Generated gases can be measured and quantified and displayed as pressure generated from the described reaction methods. A small (20 ml) sample has been shown as producing oxygen and hydrogen gasses at over 2000 psi when maintained in a sealed vessel at 72° F. Pressure is the force applied perpendicular to the surface of an object per unit area over which that force is distributed. Gauge pressure is the pressure relative to the ambient pressure. Various units are used to express pressure. Some of these derive from a unit of force divided by a unit of area; the SI unit of pressure, the pascal (Pa), for example, is one newton per square meter (N/m²); similarly, the pound-force per square inch (psi) is the traditional unit of pressure in the imperial and U.S. customary systems. Pressure may also be expressed in terms of standard atmospheric pressure; the atmosphere (atm) is equal to this pressure, and the torr is defined as 1/760 of this.

According to various embodiments of the methods and systems described herein, photons applied to an oxidizing agent can cause oxygen to oxygen bonds, hydrogen to hydrogen, and oxygen to hydrogen bonds (as well as other chemical bonds) to break. This occurs when the photon energy exceeds the bond energy. The exogenous photons applied to the oxidizing agent separates electrons from their orbits. Hydrogen peroxide is commonly found as a percent of H₂O₂ in H₂O. Both hydrogen peroxide and water have oxygen to hydrogen covalent bonds. Hydrogen peroxide also has an oxygen to oxygen single bond which is weak when compared to other oxygen molecules such as oxygen molecule bond energy of 498 kJ/mol; trioxygen bond energy of 364 kJ/mol and hydrogen peroxide oxygen to oxygen bond energy of 142 kJ/mol. Photon emissions with sufficient energy targeted to areas or containers with oxidizing agents can cause oxygen to hydrogen covalent bonds, and oxygen to oxygen, and hydrogen to hydrogen bonds to break freeing an electron. This is evident in measurable pressure generated from embodiments of the described reaction.

Exogenous photon emissions with wavelengths of 0.01 nm through 845 nm directed at oxidizing agents breaks chemical bonds and frees electrons. This generates EMODs, ROS and free radicals such as hydrogen and its ions, oxygen and its ions, hydrons, trioxidane, and other free radicals. The pressure from the released gases can be captured and measured. Oxidizing agents that have been exposed to photon emissions can subsequently be placed in pressure vessels where the evolving gases are not allowed to escape. If these pressure vessels reflect and scatter x-ray photons, then endogenous generated x-ray photons perpetuate the described self-sustaining reaction displayed by embodiments of this disclosure.

According to various embodiments, a self-sustained reaction that generates EMODs, ROS, hydrogen and its ions, oxygen and its ions, hydrons, trioxidane, and other free radicals is created and exists until one of the reactants is depleted. The elevated reactivity of the photon augmented oxidizing agent can be demonstrated for extended periods of time. The more x-ray reflective the container holding the PAOA, the greater the self-sustained reaction that is created. Embodiments of this disclosure utilize the reflecting and scattering effect of radiation to modulate the self-sustained circuit of reactions described herein. A threshold in reflectiveness and scattering can be reached so that the synergistic self-sustained circuit of reactions progresses without outside (exogenous) photons being directed at the reactants. This threshold can be surpassed so that the reactions described in this disclosure continue to grow. This continued growth can be demonstrated by an increasing pressure in the reaction container, by an increase in readings on an ORP (oxidative and reduction potential) meter, or by an increase in the electrical current potential when tested with a voltage meter.

In various embodiments, the described reactions can take place in many areas. The reactions can be performed in a container where the photon emissions are directed at the oxidizing agent generating photon augmented oxidizing agents (PAOA). The PAOA can be applied to a target to be treated. This target can be an atom or molecule or an area where the reactions of this disclosure are desired. The reactions can be performed in ambient air where an oxidizing agent is sprayed, misted, fogged or otherwise applied to the air then the airborne oxidizing agent can be exposed to photons to generate the PAOA. The reaction area can be a location where the oxidizing agent is exposed to the generated photons described in this disclosure. These photons can be generated by any desired means including x-ray generators, LEDs, bulbs, arc lights, plasma lights, or any other suitable method. These examples of areas and photon generators are not meant to be all inclusive but are meant to serve as examples of areas where the reactions may occur and examples of methods or devices that may generate photons for the reactions.

Various embodiments of the described methods and systems may produce precipitates in air, liquid, plasma and solids as a result of the reactions. These products may have desired applications or uses. Precipitates produced as a result of the described methods may be separated and collected from reactants. This separation and collection may involve centrifugation, filtration or any other suitable means. The methods described involve the reactions resulting from the interactions between oxidizing agents and photons of certain wavelengths and frequency. The oxidizing agent or oxidizing agents may be introduced to the reaction area by a pump, mist, fog, spray, dripline, or any other suitable component. This oxidizing agent introducing component functions so that the photon emitting component exposes the oxidizing agent or oxidizing agents to the photons either before the oxidizing agent is applied to a target or while the oxidizing agent is applied to a target or after an oxidizing agent is applied to a target or a combination of these. A target may be an area or substance or place where the described reaction methods of this disclosure are to react or take place.

The intensity of an x-ray beam is reduced by interaction with the matter it encounters. This attenuation results from interactions of individual photons with atoms in the target matter. The x-ray photons are either absorbed or scattered. In scattering, photons are ejected out of the primary beam as a result of interactions with the orbital electrons of absorber atoms. Three mechanisms exist where these interactions take place, (1) Coherent scattering, (2) Compton scattering, and (3) photoelectric absorption. In addition, a portion of the primary photons pass through the target matter without interaction.

Coherent scattering may occur when a low-energy incident photon passes near an outer electron of an atom (which has a low binding energy). The incident photon interacts with the electron in the outer-shell by causing it to vibrate momentarily at the same frequency as the incoming photon. The incident photon then ceases to exist. The vibration causes the electron to radiate energy in the form of another x-ray photon with the same frequency and energy as in the incident photon. In effect, the direction of the incident x-ray photon is altered. This interaction accounts for only a small number of the total number of interactions.

Compton scattering occurs when a photon interacts with an outer orbital electron, which receives kinetic energy and recoils from the point of impact. The incident photon is then deflected by its interaction and is scattered from the site of the collision. The energy of the scattered photon equals the energy of the incident photon minus the kinetic energy gained by the recoil electron plus its bonding energy. As with photoelectric absorption, Compton scattering results in the loss of an electron and ionization of the absorbing atom. Scattered photons travel in all directions. The higher the energy of the incident photon, however, the greater the probability that the angle of scatter of the secondary photon will be small and its direction will be forward. The probability of Compton scattering is directly proportional to the electron density.

Photoelectric absorption occurs when an incident photon collides with an inner-shell electron in an atom of the absorbing medium resulting in total absorption and the incident photon ceases to exist. The electron is ejected from its shell, resulting in ionization and becomes a recoil electron (photoelectron). The kinetic energy imparted to the recoil electron is equal to the energy of the incident photon minus that used to overcome the binding energy of the electron. Most photoelectric interactions occur in the K shell because the density of the electron cloud is greater in this region and a higher probability of interaction exists. An atom that has participated in photoelectric interaction is ionized. This electron deficiency (usually in the K shell) is instantly filled, usually by an L- or M- shell electron, with the release of characteristic radiation. The frequency of photoelectric interaction varies directly with the third power of the atomic number of the absorber.

In both photoelectric absorption and Compton scattering, electrons are ejected from their orbits in the absorbing material after interaction with exogenous and/or endogenous x-ray photons. These secondary electrons give up their energy in the absorber by either of two processes: (1) collisional interaction with other electrons, resulting in ionization or excitation of the affected atom, and (2) radiative interactions, which produce bremsstrahlung radiation resulting in the emission of low-energy x-ray photons. Secondary electrons eventually dissipate all their energy, mostly as heat (phonons) by collisional interaction and come to rest. FIG. 7 shows the tremendous pressure generated by this system.

In FIG. 7, the canister on the left contains H₂O₂ exposed to photon emissions from 0.01 nm - 845 nm. The canister on the right contains H₂O₂ that was not exposed to photon emissions. Both canisters are composed of x-ray reflective material. The photo was taken 48 hours after photon exposure to the H₂O₂ in the container on the left. This demonstrates the reactive potential, shelf life, and self-sustaining circuit of reactions displayed according to embodiments of methods of this disclosure.

Pressure is a form of stored power. In the sense that pressure is an amount of force per unit area while energy is the amount of work per unit time. For physicists, the amount of work per unit time is referred to as power. Current literature on hydrogen peroxide does not reference pressure as a form of its power/energy. Most likely, it is because very little pressure is generated in systems utilizing H₂O₂. If a system has a constant number of particles and is transitioning between states of equivalent entropy then the pressure is the rate of change of the total internal energy of the system, with respect to the volume. Since energy is usually globally conserved by Noether’s theorem, this is equivalent to stating, “pressure is the capacity for a closed system to do work when it changes volume.”

The stored pressure from the hydrogen and oxygen generated by various embodiments of the disclosure is stored energy. The generated pressure has not been described in hydrogen peroxide uses previous to the present disclosure. This pressure is a measure of kinetic energy per unit volume. The kinetic energy density causes the particles to push against the walls of a container all the time. That is how pressure can do work. Because a system under pressure has the potential to perform work on its surroundings, pressure is a measure of potential energy stored per unit volume. The present methods and systems relate to the tremendous pressure that can be created by embodiments of the disclosure.

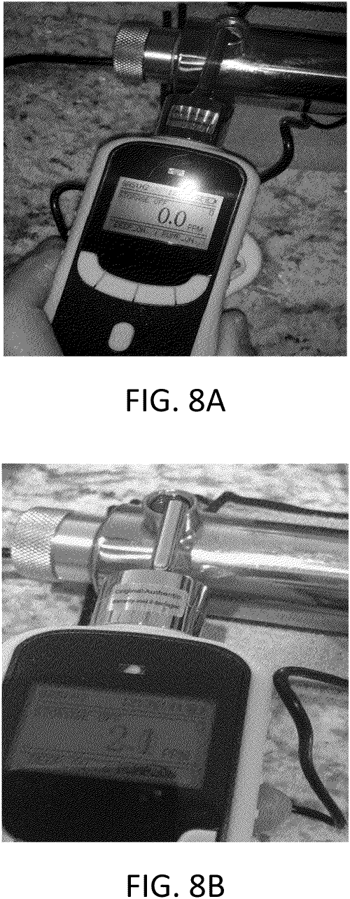

FIG. 8A is photograph of a hydrogen detection meter with the detection probe directed at the opening in the photon activation chamber. The photon activation chamber is OFF so the reading on the meter is ZERO ppm. FIG. 8B is a photograph of a hydrogen detection meter with the detection probe directed at the opening in the photon activation chamber. The photon activation chamber is ON and the reading on the meter shows the generated hydrogen from reactions displayed by embodiments of the disclosure. This demonstrates the generation of hydrogen and the self-sustaining circuit of reactions provided by various embodiments of the methods and systems in the present disclosure.

As used herein, the word “exemplary” means “serving as an example, instance, or illustration.” The embodiments described herein are not limiting, but rather are exemplary only. The described embodiments are not necessarily to be construed as preferred or advantageous over other embodiments. Moreover, the terms “embodiment or “embodiments” do not require that all embodiments of the disclosure include the discussed feature, advantage, or mode of operation.

As used herein, the terms “and/or” and “and or” as used herein means that two or more elements are to be taken together or individually. Thus, “A and/or B” and “A and or B” cover embodiments having element A alone, element B alone, or elements A and B taken together.

In the methods and systems disclosed herein, methods of utilizing both homogeneous and heterogeneous photocatalytic (PCA) reactions are described. By utilizing both types of PCA, a photon augmented self-sustaining reaction is produced resulting in generated electronically modified oxygen derivatives (MODs), reactive oxygen species (ROS), hydrogen and its ions, oxygen and its ions, hydrons, trioxidane, and other free radicals that are continuously produced as long as reactants are present. In various embodiments, generated gases may be vented by an appropriate means desired or these gases may be retained. This venting may control or modulate the reaction. As an example, the produced gases may be totally captured to preserve the highest reaction potential, or the generated gases may be fully vented if the reaction potential needs to be reduced or halted.

In some embodiments, trioxygen is one of the potential photocatalysts generated by the described reactions in this disclosure. Trioxygen and the endogenous x-ray photons produced results in an increased efficacy and a shelf life of increased and sustainable reactivity in the PAOA when compared and contrasted with oxidizing agents that are not exposed and augmented with exogenous photon emissions. Research has found that trioxidane is an active ingredient responsible for the antimicrobial properties of the ozone/hydrogen peroxide mix. Because these two compounds are present in biological systems as well it is argued that an antibody in the human body can generate trioxidane as a powerful oxidant against invading bacteria. Trioxidane can be obtained in small, but detectable, amounts in reactions of ozone and hydrogen peroxide.

Ionizing radiation contains subatomic particles or electromagnetic waves that have sufficient energy to ionize atoms or molecules by detaching electrons from them. Gamma rays, x-rays, and some parts of the ultraviolet part of the electromagnetic spectrum are commonly considered ionizing radiation, whereas visible light, nearly all types of laser light, infrared, microwaves, and radio waves are commonly considered non-ionizing radiation. The boundary between ionizing and non-ionizing radiation is not sharply defined because different molecules and atoms ionize at different energies. Photons may be called x-rays if they are produced by electron interactions, and they are of the appropriate wavelengths. An x-ray photon has a wavelength of 0.01 to 10 nanometers, with a frequency of 3×10¹⁶ Hz to 3×10¹⁹ Hz. It possesses enough energy (100 eV to 100 keV) to disrupt molecular bonds and ionize atoms making it, by definition, ionizing radiation.

The energy of ionizing radiation is between 10 electronvolts (eV) and 33 eV. Even though photons are electrically neutral, they can ionize atoms indirectly through the photoelectric effect and the Compton effect. Either of those interactions will cause the ejection of an electron from an atom at relativistic speeds, turning that electron into a beta particle (secondary beta particle) that will ionize other atoms. Beta particles (β) are high-energy, high-speed electrons (β-) or positrons (β+) that are ejected from an atom. As they have a small mass and can be released with high energy, they can reach relativistic speeds (close to the speed of light). In a photon enhanced heterogeneous system, when the two phases each constitute a significant fraction of the total mass, the ionizing energy is absorbed significantly by both phases. After the absorption of a high-energy photon, a high energy Compton electron is ejected. This electron induces a large number of secondary electrons of energies in the 100 eV range.

According to various embodiments of this disclosure, most of the ionized atoms are due to the secondary beta particles, photons endogenously produced within the methods described herein are indirect ionizing radiation. Radiated photons are called gamma rays if they are produced by a nuclear reaction, subatomic particle decay, or radioactive decay within the nucleus. They are called x-rays if produced outside the nucleus. An x-ray is a packet of electromagnetic energy (photon) that originates from the electron cloud of an atom. This is generally caused by energy changes in an electron, when it moves from a higher energy level to a lower one, causing the excess energy to be released. X-rays are similar to gamma rays in many respects however the main difference is the way they are produced. X-rays are produced by electrons external to the nucleus. The generic term “photon” is used to describe both. X-rays have a lower energy than gamma rays.

Photoelectric absorption is the dominant mechanism of interaction in organic materials for photon energies below 100 keV. At energies beyond 100 keV, photons ionize matter increasingly through the Compton effect, and then indirectly through pair production at energies beyond 5 MeV. In a scattering event, the photon transfers energy to an electron, and then continues on its path in a different direction and with reduced energy. The x-ray photons produced in this manner range in energy from near zero up to the energy of the electrons. An incoming photon may also collide with an atom in the target, kicking out an electron and leaving a vacancy in one of the atom’s electron shells. Another electron may fill the vacancy and in so doing release an X-ray photon of a specific energy.

Bremsstrahlung radiation is electromagnetic radiation produced by the deceleration of a charged particle when deflected by another charged particle. The moving particle loses kinetic energy, which is converted into radiation (photons), thus satisfying the law of conservation of energy. X-rays are emitted as the electrons slow down (decelerate). The output spectrum contains a continuous spectrum of x-rays, with additional sharp peaks at certain energies. The continuous spectrum is due to bremsstrahlung, while the sharp peaks are characteristic x-rays associated with the atoms in the target. Bremsstrahlung radiation is a type of “secondary radiation” in that it is produced as a result of stopping (or slowing) of the primary photon radiation. Ionization of molecules can lead to radiolysis (breaking chemical bonds) and formation of highly reactive free radicals. These free radicals may then react chemically with neighboring materials even after the original radiation has stopped. Ionizing radiation can also accelerate existing chemical reactions by contributing to the activation energy required for the reaction.

Compton scattering is the scattering of a photon after an interaction with a charged particle, usually an electron. If it results in a decrease in energy of the photon, it is called the Compton effect. Part of the energy of the photon is transferred to the recoiling electron. Inverse Compton Scattering occurs when a charged particle transfers part of its energy to a photon. As given by Compton, the explanation of the Compton shift is that in the target material valence electrons are loosely bound in the atoms and behave like free electrons. Compton assumed that the incident x-ray radiation is a stream of photons. An incoming photon in this stream collides with a valence electron in the target. During this collision, the incoming photon transfers some of its energy and momentum to the target electron and leaves the scene as a scattered photon. Simply, a photon that has lost some of its energy emerges as a photon with a lower frequency, or equivalently, with a longer wavelength.

Various embodiments described herein take advantage of PETE, exogenous applied photons, endogenous generated photons, the photoelectric effect, and the Compton effect to excite electrons in target materials while generating EMODs and ROS, hydrogen and its ions, oxygen and its ions, hydrons, and other free radicals. ROS are highly reactive chemicals formed from O₂. Examples of ROS include peroxides, super oxides, hydroxyl radicals, trioxygen, singlet oxygen, and alpha oxygen. The reduction of molecular oxygen (O₂) produces superoxide (^{·}O⁻₂), which is the precursor to most other reactive oxygen species:

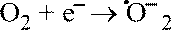

Dismutation of superoxide produces hydrogen peroxide (H₂O₂):

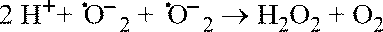

Hydrogen peroxide in turn may be partially reduced, thus forming, hydrogen ions, hydroxide ions, and hydroxyl radicals (^{·}OH), or fully reduced to water:

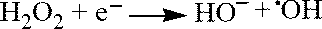

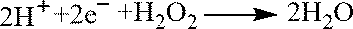

EMODs, ROS, hydrogen and its ions, oxygen and its ions, hydrons, and other free radicals generated by various embodiments of this disclosure continue to react with target materials and/or target areas even after the application of exogenous photon application has stopped. If the reaction of EMODs, ROS, hydrogen and its ions, oxygen and its ions, free radicals, trioxidane, and endogenous x-ray photons with an oxidizing agent generates x-ray photons, a self-sustaining reaction can be created that further produces EMODs, ROS, hydrogen and its ions, oxygen and its ions, hydrons, and other free radicals. X-ray photons scattered by a set of atoms produce x-ray radiation in all directions, leading to interferences due to the coherent phase differences between the interatomic vectors that describe the relative position of atoms. In a molecule or in an aggregate of atoms, this effect is known as the effect of internal interference, while we refer to an external interference as the effect that occurs between molecules or aggregates.

As mentioned previously in this disclosure, multi-proton absorption(MPA) contributes to the production of EMODs, ROS, hydrogen and its ions, oxygen and its ions, hydrons, other free radicals, and endogenous x-ray photons. MPA and its effects have been ignored or under appreciated by previous disclosures. The self-sustained circuit of reactions employed by embodiments of the present disclosure generate EMODs, ROS, hydrogen and its ions, oxygen and its ions, hydrons and free radicals, trioxidane, and endogenous x-ray photons at rates that previously have not been demonstrated.

Water absorbs UV radiation near 125 nm, exiting the 3a1 orbit and leading to dissociation into OH⁻ and H⁺. Through MPA, this dissociation can also be achieved by two or more photons at other nm wavelengths. This creates reactions and products, and embodiments in the present disclosure, that have not been previously demonstrated, reported or understood. Multi-photon absorption (MPA) and two photon absorption (TPA) are terms used to describe a process in which an atom or molecule makes a single transition between two of its allowed energy levels by absorbing the energy from more than a single photon. This can generate ionization and oxidation of substances involved in the reactions releasing beta particles, endogenous x-ray photons, EMODs, ROS, hydrogen and its ions, oxygen and its ions, hydrons, trioxidane, and other free radicals.

Chemi-excitation via oxidative stress by reactive oxygen species, electronically modified oxygen derivatives, reactive nitrogen species (RNS), hydrogen and its ions, oxygen and its ions, hydrons, trioxidane, and/or catalysis by enzymes is a common event in biomolecular systems. Various embodiments of the present disclosure relate to utilizing exogenous applied photons and endogenous generated photons in a synergistic chemi-excitation process that generates ROS, EMODs, hydrogen and its ions, oxygen and its ions, endogenous x-ray photons, beta particles, hydrons, trioxidane, and other free radicals. According to various embodiments of the present disclosure, such reactions may lead to the formation of triplet excited species such as trioxygen (ozone, O₃), hydroxyl radicals, hydrons, trioxidane, and other free radicals. This process contributes to spontaneous biophoton emission. In further embodiments, photon emission is increased by the generation of endogenous photons that generate ROS, EMOD, hydrogen and its ions, oxygen and its ions, beta particles, x-ray photons, hydrons, and other free radicals such as hydroxyl radicals, hydroperoxides, singlet oxygen, hydrogen, superoxide, and others.

Electromagnetic radiation moves in a vacuum at a universal speed. This is the speed of light, c=30,000,000,000 centimeters per second (usually written in powers of ten, c=3×10¹⁰ cm/sec). The constant value of the speed of light in vacuum goes against our intuition: we would expect that high energy (short wavelength) radiation would move faster than low energy (long wavelength) radiation. We can consider light as a stream of minute packets of energy, photons and biophotons and generated phonons, which creates a pulsating electromagnetic disturbance. A single photon or biophoton differs from another photon or biophoton only by its energy. In empty space (vacuum), all photons and biophotons travel with the same speed or velocity.

Photons and biophotons are slowed down, generating phonons and/or interacting with atoms or molecules thereby releasing electrons and endogenous photons, when they interact with different media such as water, glass or even air. This slowing down accounts for the refraction or bending of light. Refraction is the bending of a wave when it enters a medium where its speed is different. The refraction of light when it passes from a fast medium to a slow medium bends the light ray toward the normal to the boundary between the two media. The amount of bending depends on the indices of refraction of the two media and is described quantitatively by Snell’s Law. As the speed of light is reduced in the slower medium, the wavelength is shortened proportionately. The energy of the photon and biophotons is not changed, but the wavelength is. Different energy photons and biophotons are slowed by different amounts in glass or water or other substances; this leads to the dispersion of electromagnetic radiation. As used herein, greater intensity of light means that more photons were available to hit a target per second and more electrons could be ejected from a target, not that there was more energy per photon or biophoton.

The energy of the outgoing electrons depends on the frequency of photons. There are two predominant kinds of interactions through which photons deposit their energy - both are with electrons. In one type of interaction the photon loses all its energy; in the other, it loses a portion of its energy, and the remaining energy is scattered. The energy (E) of the incoming photons and biophotons is directly proportional to the frequency, which can be written as E = hf in which h is a constant. Max Planck first proposed this relationship between energy and frequency in 1900 as part of his study of the way in which heated solids emit radiation. In one example, the photoelectric (photon-electron) interaction, a photon transfers all its energy to an electron located in one of the atomic shells. The electron is then ejected from the atom by this energy and begins to pass through the surrounding matter. The electron rapidly loses its energy and moves only a relatively short distance from its original location. The photon’s energy is deposited in the matter close to the site of the photoelectric interaction. The energy transfer is a two-step process. The photoelectric interaction in which the photon transfers its energy to the electron is the first step. The depositing of the energy in the surrounding matter by the electron is the second step. PETE and electrons are the two main types of elementary particles or excitations generated with photon reactions. MPA increases the photoelectric interactions described in this disclosure. MPA increases the amount of energy available to be deposited in the surrounding matter.

If the binding energy is more than the energy of the photon, a photoelectric interaction cannot occur. This interaction is possible only when the photon has sufficient energy to overcome (ionize) the binding energy and remove the electron from the atom or a MPA reaction can occur depositing more energy. The photon’s energy is divided into two parts by the interaction. A portion of the energy is used to overcome the electron’s binding energy and to remove it from the atom. The remaining energy is transferred to the electron as kinetic energy (PETE) and is deposited near the interaction site. Since the interaction creates a vacancy in one of the electron shells, typically the K or L, an electron moves down to fill in the vacancy. Even though photons are electrically neutral, they can ionize atoms indirectly through the photoelectric effect and the Compton effect. The Compton effect is a partial absorption process as the original photon has lost energy, known as Compton shift (a shift of wavelength/frequency). Either of those interactions may cause the ejection of an electron from an atom at relativistic speeds, turning that electron into a x-ray photon (secondary particle) that may ionize other atoms. Since most of the ionized atoms are due to the secondary particles, endogenous photons may also be indirectly ionizing radiation. Radiated photons are also called gamma rays if they are produced by a nuclear reaction, subatomic particle decay, or radioactive decay within the nucleus. They are called x-rays if produced outside the nucleus. The generic term “photon” is used to describe both.

The closer the electron is to the nucleus, the higher the binding energy of the shell. This is the result of the positive attraction of the protons in the nucleus. Therefore, K electron shell will have the highest energy, then L, then M and so forth. The incident electron interacts with an electron by removing it from the atom (ionization). When the target atom is ionized, it creates a hole in the electron shell. The “hole” makes the atom unstable and in an effort to stabilize itself an electron from another shell jumps down to fill the “hole”. The energy the electron must give up to jump into the hole becomes a x-ray photon. When x-ray photons are produced, they are produced isotropically (in all directions). The drop in energy of the filling electron often produces this characteristic endogenous x-ray photon. The energy of the characteristic radiation depends on the binding energy of the electrons involved. Characteristic radiation initiated by an incoming photon is referred to as fluorescent radiation. Fluorescence, in general, is a process in which some of the energy of a photon is used to create a second photon of less energy. This process sometimes converts x-rays into light photons. Whether the fluorescent radiation is in the form of light or x-rays depends on the binding energy levels in the absorbing material.

As defined herein, the linear attenuation coefficient (µ) is the actual fraction of photons interacting per 1-unit thickness of material. Linear attenuation coefficient values indicate the rate at which photons interact as they move through material and are inversely related to the average distance photons travel before interacting. The rate at which photons interact (attenuation coefficient value) is determined by the energy of the individual photons or the MPAs, and the atomic number and density of the material. This is important to the activation of the photon augmented antimicrobial oxidizing agent according to various embodiments of this disclosure. In some situations, it is more desirable to express the attenuation rate in terms of the mass of the material encountered by the photons rather than in terms of distance. The quantity that affects attenuation rate is not the total mass of an object but rather the area mass. Area mass is the amount of material behind a 1-unit surface area, and is the product of material thickness and density:

Area Mass (g/cm²) = Thickness (cm) × Density (g/cm³).

The mass attenuation coefficient, using this formula, is the rate of photon interactions per 1-unit (g/cm²) area mass. According to various embodiments of this disclosure, by establishing a linear attenuation coefficient that does not diminish too rapidly with the functioning distance so that sufficient numbers of photons are available for enhancement of the oxidizing agent, an effective proton augmented antimicrobial, augmented catalyst, augmented bleaching agent, or augmented other described effects electronically modified oxygen derivatives, reactive oxygen species, hydrogen and its ions, oxygen and its ions, hydrons and other free radicals are generated. In various embodiments, the augmented antimicrobial, catalyst, bleaching agent, or other described reactants are used in the disclosed process in plasma, liquid, gas, solid, or a combination of these states of matter. The photon AOAs generated in this disclosure function in various embodiments of the agglomeration process disclosed herein.

Brownian diffusion is the characteristic random wiggling motion of small particles, resulting from constant bombardment by surrounding molecules. Such irregular motions of pollen grains in water were first observed by the botanist Robert Brown in 1827, and later similar phenomena were found for small smoke particles in air. In agglomeration, suspended particles tend to adhere one to the other creating bigger and heavier aggregates. The agglomeration process includes the transportation and collision of particles, and the attachment of the particles. Understanding particle agglomeration and aggregation and the mechanisms that cause such assemblies, such as diffusion, is important in a wide range of processes and applications.

As used herein, aggregation and agglomeration are two terms that are used to describe the assemblage of particles in a sample, but clustering via agglomeration is irreversible. The main transport mechanisms by which particles can collide are Brownian motion, laminar or turbulent flow, relative particle settling, and gravitational agglomeration. In various embodiments of the disclosure, gravitational agglomeration, which is dependent on the size of the particles and their terminal velocity, is one component relating to the separation of particles in air, solutions or associated with a compound or material. Slowly settling particles interact with the more rapidly settling particles, leading to the formation of clusters. This process can be called agglomeration. Several different basic effects have been studied as being responsible for particle collision and agglomeration, which are mainly orthokinetic and hydrodynamic forces. Brownian diffusion is instrumental in particle size selection for diffusion of photon augmented oxidizing agent solutions dispersed in a fog, mist, vapor, spray, bolus, drop, stream, or other methods of dispersion.

Rates of reaction are based on collision theory. Increasing the number of collisions can lead to faster reaction rate. Increasing the concentration of reactants causes more collisions and so a faster reaction rate. Temperature increases the speed of the particles so more collisions and a faster reaction rate as described previously with PAOA and PETE. Size of particles has an effect on solubility reactions so smaller pieces or smaller droplets have greater surface areas relative to the volume. A decrease in particle size causes an increase in the substance’s total surface area when concentration remains unchanged.

Liquids evaporate only from the surface of a droplet. If the surface area of the droplet in relation to the volume is decreased, then the evaporation efficiency is increased. A substance existing in a liquid phase can be transferred to a gaseous phase by utilizing and controlling droplet size. The time needed for this phase transfer can be regulated by selecting the proper sized droplet.

TABLE 1

| FOG CLASSIFICATION | DROPLET SIZE In microns | TIME FOR PARTICLE TO FALL 10 FEET (SECONDS) |
|---|---|---|
| Wet Fog | 11-49 | 40 - 1,020 |
| Dry Fog | 6-10 | 1,019 - 12,000 |
| Extreme Dry Fog | 2-4 | 12,001 - 25,400 |
| Sub 2 Micron Dry Fog | < 2 | >25,400 |

As shown in Table 1, the smaller the droplet size, the longer it can stay air borne. Therefore, the smaller the droplet size the faster and more efficient evaporation is achieved. According to various embodiments, the various micron-sized droplets created by the systems described in the present disclosure evaporate at selected rates depending on application needs. In some embodiments, small size particles are selected, and they are sized so that they completely evaporate into the air before reaching most surfaces. This near 100% evaporation rate achieves near 100% chemical efficiency. In some embodiments, the particle fall rate is calculated based on density, size, and mass of the particle as well as the density of the air or gas it is placed in. Humidity also influences the fall rate outcome because at a low humidity a particle will tend to evaporate faster and lose size and mass as it remains air borne. These factors, when based on the methods of this disclosure, enable various embodiments of a selected size micron fog microbial suppression system, and/or agglomeration system, and/or bleaching system, or other applicable system to utilize an extremely low volume and low concentration of a photon augmented oxidizing agent solution. These solutions generate endogenous x-ray photons that create a self-sustaining circuit of reactions.

This self-sustaining circuit of reactions can be intensified by placing the PAOA in a container or area where the endogenous x-ray photons can be reflected back into the PAOA. By reflecting these endogenous x-ray photons back into the PAOA, they are available to further ionize the PAOA solution. This creates a PAOA solution that is more reactive and reactive longer than an oxidizing agent solution that is not augmented with photons as described in this disclosure. This is evident by the graphs and charts included in this disclosure.

According to various embodiments, the PAOA solution is deposited into a volume of liquid, plasma, air, or gas, or other suitable medium. In various embodiments, this is done through an existing HVAC system, a fogging device, a sprayer, a mister, an injector, a dropper, a spray can, an aerial spraying device, crop dusting, or other suitable devices. Various embodiments of the photon augmented oxidizing agent system exhibit such a slow particle fall rate that when it is combined with the simultaneous phase change of these particles that a concentration of gas vapor (e.g., of air borne dispersion) is created and maintained of the photon augmented oxidizing agent in the air.

The present disclosure is further directed to a method and system for progressive regression of Colony Forming Units (CFUs) from the continuous presence of a photon enhanced microbial suppression system utilizing photon augmented oxidizing agents. Embodiments of the system provide a decontamination system that includes a photon enhanced microbial suppression system solution, the PAOA, and its effects on substances that it contacts. Various embodiments utilize a MPA, PETE, and a PAOA containing microbial suppression system that includes particle size considerations for controlled dispersion and addresses agglomeration of inactivated microbes and other precipitates in a multi-faceted technology described by the system of this disclosure. In various embodiments, this combination provides a system of decontaminating areas, structures, food, liquids, animals, animal fluids, plants, buildings, pipelines, homes, offices, indoors and outdoors. Some embodiments feature low chemical concentrations made more effective with the combination of the photon augmented oxidizing agent microbial suppression system, so that there are reduced or no harmful effects on humans or animals or plants when administered at these low concentrations, and so exposure to the PAOA agents can be on going, constant, or nearly constant. This low concentration contrasts sharply with oxidizing agent solutions that have not been augmented with photon emissions as described in this disclosure.

A PAOA antimicrobial solution applied to ambient air in a room exhibits an antimicrobial effect at concentrations at a level below published OSHA safety limits for oxidizing agent concentration in air in a habited environment. An oxidizing agent solution that has not been augmented with photons as described in this disclosure would have to be applied at concentration over 100 times the allowable OSHA safety limit to achieve similar microbial reduction in the ambient air in a room. This increased efficacy results from the increased quantities of generated endogenous x-ray photons, hydrogen and its ions, oxygen and its ions, hydrons, ROS, EMODs and other free radicals in the photon augmented oxidizing agents as compared to oxidizing agents that have not been exposed to photon emissions from 0.01 nm through 845 nm.

According to various embodiments, another use of the photon augmented oxidizing agent system involves the dissociation of blood and other animal fluids. As a non-limiting example, blood cells contain a dramatic amount of potentially usable components such as proteins, fats, minerals, elements, and small molecular weight constituents that once separated allow disposal or repurposing of the resultant liquid in environmentally sound methods such as irrigation of crops. Animal fluids, blood, blood cells, microbes, and organic matter tend to be more difficult to dispose of as compared to serum or plasma. Blood, for example, tends to be less stable and contains total dissolved solids (TDS), total suspended solids (TSS), microbes and other components that complicate its disposal unless it is dissociated and separated. This is one of the major reasons why, for example, blood plasma (often simply referred to as plasma, i.e., an anticoagulated whole blood sample; deprived of cells and erythrocytes) and blood serum (often simply referred to as serum, i.e., coagulated whole blood; deprived of cells, erythrocytes, and most proteins of the coagulation system, especially of fibrin/ fibrinogen) are considered biohazards. Various embodiments of the present disclosure include a decontamination system whereby blood components go through the described agglomeration process whereby photon augmented oxidizing agents are added to the blood causing dissociation of the blood into constituent components allowing for these components to be used for their water value and nutritional value and other desired purposes.

As used herein, organic matter pertains to any carbon-based compound that exists in nature. Living things are described as organic since they are composed of organic compounds. Examples of organic compounds are carbohydrates, lipids, proteins, and nucleic acids. Since they contain carbon-based compounds, they are broken down into smaller, simpler compounds through decomposition and through dissociation when exposed to oxidizing agents that have been subject to photon emissions from 0.01 nm through 845 nm. Living organisms also excrete or secrete material that is considered an organic material. The organic matter from blood contains useful substances that have value when separated from the blood. This organic matter contains substances that can be repurposed as food sources, as fertilizer, as medicines, or other uses. According to various embodiments, the decontaminated liquid that has had particles removed through agglomeration when exposed to oxidizing agents that have been exposed to photon emissions from 0.01 nm through 845 nm will be rendered microbe free and may be used to irrigate land and/or for liquids for animals to ingest. In a period of time where water for animal ingestion is becoming a more scarce and valuable commodity, this embodiment provides a new source of nutritious water for animals and provides microbe free water for irrigation. In various embodiments, the photon emissions are a single wavelength or exist as multiple wavelengths.

According to various embodiment, reactions described in the present disclosure provide a multitude of uses. In some embodiments, such as HVAC applications, a low concentration of 1 part per million (ppm) of a photon augmented oxidizing agent or even less than 1 ppm may be used to decontaminate ambient air and surfaces that are exposed to the PAOA. In other embodiments, a higher concentration of augmented oxidizing agents of 50% or more may be advantageous. In various embodiments, variables such as temperature, opacity of reactants, pH and others influence the selection of the concentration of oxidizing agents. In some embodiments, a PAOA is added to a substance (target) for antimicrobial purposes. In some embodiments, the effect of the photon emissions takes place at a certain time or place relative to the desired outcome of the reaction associated with the described methods. In these embodiments, the photon emissions will not be applied to the oxidizing agent/target mixture until such time as the photon enhanced reaction is desired to take place. In other instances, the photon emissions are applied to the oxidizing agent before it is applied to the target/mixture to be treated. An example of this is an antimicrobial and agglomeration effect in a HVAC system where applying the photon emissions to the oxidizing agent is better suited to applying the PAOA into a HVAC ductwork or blower than applying the photon emissions and oxidizing agent to the entire volume of ambient air of the HVAC system in a room or enclosure.

At present, appropriate separation/handling of animal fluids, blood, blood cells, microbes, and organic matter, e.g., by centrifugation, filtration, heating, cooling, precipitation, or analyte extraction is essential, before such processed samples can be properly and reliably disposed of or repurposed. As disclosed above, serum or plasma may be obtained from whole blood and repurposed as nutrients, fertilizer, or disposed of as needed. Cells, cell constituents, microbes, organic matter, and erythrocytes may also be removed by filtration and/or centrifugation from blood or blood components or from other animal fluids but a lower cost method is desired over present commercially available techniques. According to various embodiments of the present disclosure, in techniques of sample processing, the animal fluids, blood, blood cells, microbes, and other organic matter of interest are first separated from the majority of substances by dissociation, agglomeration, and/or extraction methods when combined with oxidizing agents that have been exposed to photon emissions from 0.01 nm through 845 nm. In various embodiments, extraction is performed in liquid phase or in a solid phase. In other embodiments, gross extraction of larger particles is sequenced with extraction methods processing progressively smaller units until the desired resolution is obtained. Various embodiments of the present disclosure allow for this process to be accomplished by photon emissions applied to oxidizing agent solutions creating a PAOA. This results in an increase in ROS, EMODs, hydrogen and its ions, oxygen and its ions, beta particles, endogenous x-rays, hydrons and other free radicals when compared and contrasted with un-augmented oxidizing agents.

In various embodiments of the present disclosure, a photon emission augmented antimicrobial oxidizing agent solution is applied to air via a HVAC system or other suitable means. In some embodiments, a small micron (less than 20 microns droplet size) mist or fog containing photon augmented microbial suppression system is selected to utilize an extremely low volume and low concentration of a photon augmented antimicrobial oxidizing agent solution into a volume of air or gas. In various embodiments, a 6-10 micron droplet size, 2-4 micron droplet size, or a sub 2 micron droplet size mist or fog of a photon augmented oxidizing agent microbial suppression system is selected. The selected droplet size is selected based on the desired fall rate of the PAOA through the ambient air. Different air qualities may be better affected by different particle sizes of PAOA.

According to various embodiments, this is done through an existing HVAC system utilizing an electrostatic fog, fogging, misting, spraying, sprinkling, diffuser, atomizer, or other suitable device. In some embodiments, the application device includes one or more of an aerosolizing nozzle producing a small micron dry fog, an air compressor to push the solution through the nozzle at the desired rate, a metering pump to dispense the solution at a rate that will give the desired concentration in ambient air, and a control system to regulate and monitor the application of the solution. In some embodiments, a small micron dry fog photon augmented oxidizing agent microbial suppression system exhibits such a slow particle fall rate that when it is combined with the simultaneous evaporation of these particles, a concentration of PAOA gas vapor is created and maintained of the photon augmented antimicrobial agent in the ambient air serviced by the HVAC system. This can also be referred to as the target. A progressive regression of CFUs from the continuous presence of the small micron dry fog microbial suppression system provides, in the ambient air, a decontamination system of air and surfaces that the small micron dry fog microbial suppression system solution contacts. In some embodiments, as the photon augmented antimicrobial oxidizing agent settles through the ambient air, it inactivates microbes, and any remaining PAOA in the ambient air decomposes into oxygen and water. In various embodiments, the small micron dry fog PAOA microbial suppression system is designed so that most of the microbial inactivation occurs in the HVAC system ducts and in the higher levels of a building’s ambient air. By design, in various embodiment, the concentration of PAOA becomes lower as it is consumed by inactivating microbes, by evaporation, and by decomposition into oxygen and water. This demonstrates another, very different application of the technology displayed in the present disclosure. The photon enhanced AOA antimicrobial and agglomeration effects, when used in HVAC systems as described, can be modulated by utilizing x-ray reflective containers or areas where the PAOA is deployed as previously described in the methods of this invention. These x-ray reflective containers or areas allow the endogenous generated x-ray photons to remain available to react with the PAOA.

Oxidative biocides (such as chlorine and hydrogen peroxide) remove electrons from susceptible chemical groups, oxidizing them, and become themselves reduced in the process. Oxidizing agents are often low-molecular-weight compounds and some are considered to pass easily through cell walls/membranes, whereupon they react with internal cellular components, leading to apoptotic and necrotic cell death. Although the biochemical mechanisms of action may differ between oxidative biocides, the physiological actions are largely similar. Oxidative biocides have multiple targets within a cell as well as in almost every biomolecule; these include peroxidation and disruption of membrane layers, oxidation of oxygen scavengers and thiol groups, enzyme inhibition, oxidation of nucleosides, impaired energy production, disruption of protein synthesis and, ultimately, cell death.

According to various embodiments of the present disclosure, a generated PAOA microbial suppression system acts like a filter in that a microbial particle cannot easily pass through it without colliding with P AOA antimicrobial particle. When a microbe collides with a PAOA antimicrobial particle, agglomeration occurs. As PAOA agglomerized microbial particles bind together, their mass increases as a unit. Gravitational forces acting on the PAOA agglomerized microbial particles increase its velocity of fall. The PAOA agglomerized microbial particles continue to gather more microbial particles as it falls through the selected medium such as liquids, air, or a gas. An analogy would be a snowball rolling downhill continually increasing in size as it advances downhill. Since PAOA antimicrobial particles contain an augmented oxidizing agent, the microbe that contacts the PAOA becomes agglomerized as it comes in contact with the PAOA antimicrobial sanitizer/disinfectant, filter particles. These agglomerized particles settle or are filtered to remove them from the solution, air, gas, liquid, or plasma.

According to various embodiments, this phenomenon is called agglomeration and solving microbial infestations with a PAOA microbial suppression particle utilizes embodiments of agglomeration described in the present disclosure. As used herein, agglomeration is the gathering of particle mass into a larger mass, or cluster. While this is occurring, embodiments of the photon augmented antimicrobial oxidizing agent is killing and/or deactivating the microbes. The agglomerated dead and/or deactivated microbe is pulled by gravitational forces and eventually settles from the substance being treated. In various embodiments, the substance is a liquid, gas, plasma, or any suitable substance targeted to be treated. This agglomeration of dead or inactivated microbes and other substances such as proteins and minerals is unique for a variety of reasons. As an example, in conditioned air, it has been shown that even in common air filters, such as HEPA filters designed to filter out microorganisms, arrested microorganisms can grow and, in some cases, “grow through” the filter medium and seed the air with an ever-increasing dose of microbes. Some organic media such as cellulose media provide nutrition for microbiological growth.

Various embodiments of the present disclosure include a progressive reduction in the microbial count as the result of the application of a PAOA enhanced antimicrobial oxidizing agent solution. This is accomplished by utilizing an antimicrobial oxidizing agent solution that has been enhanced with photons to increase its effectiveness as explained previously in this disclosure. According to various embodiments, the wavelength of the photons utilized is this disclosure to generate photon AOA is from 0.01 nm through 845 nm. In various embodiments, the wavelength of the photons is 0.01 nm through 845 nm or any combination of wavelengths in this range.

In various embodiments, one or more of trioxygen, endogenous x-rays, beta particles, hydrons, oxygen and its ions, and hydrogen and its ions are generated when the oxidizing agent is exposed to the photons of 0.01 nm through 845 nm and this creates a self-sustaining circuit of reactions that generates electronically modified oxygen derivatives (EMODs), ROS, hydrons, hydrogen and its ions, oxygen and its ions, beta particles, x-rays, and other free radicals as long as conditions allow. Various embodiments utilize hydrogen peroxide as an oxidizing agent in liquid form and ambient air as a gas. In various embodiments, the described reactions take place with reactants in different states of matter.

In an example an embodiment of a system for progressive reduction of the microbial count in ambient air, a room with 1,000,000 colony forming units (CFUs) is equipped with a HVAC system for performing the methods as disclosed herein. A small micron PAOA antimicrobial dry fog is administered into the ambient air through an existing HVAC system at a concentration of less than 1 part per million. This low concentration PAOA causes a reduction in the microbial CFUs as the small micron PAOA dry fog slowly settles through the air killing microbial CFUs at a rate of about 20%. After 20 minutes, the continuously administered small micron PAOA antimicrobial fog reduces the 1,000,000 CFUs by 20% to 800,000 CFUs. As the progressive regression of microbes continues, the microbial CFU count drops and after 1 hour of continuous treatment the microbial CFU count is at 512,000. With continued progressive regression, there are 262,144 CFUs of microbes in the PAOA treated air after 2 hours and 134,217 microbial CFUs after 3 hours. The ambient air continues to get cleaner and cleaner and after 5 hours the progressive regression of the microbial count with an embodiment of this PAOA system of small micron PAOA antimicrobial oxidizing agent dry fog with a photon augmented oxidizing agent has reduced the microbial CFU count to 35,184 CFUs of microbes. By continuing this PAOA reaction out for 8 hours, the microbial CFU count is reduced to 4772 CFUs. That’s a 99.5% reduction in the microbial count in the PAOA treated air over an 8 hour period utilizing a progressive regression of microbes achievable with embodiments of the methods described in the present disclosure. In contrast, independent research lab testing shows little or no microbial reduction with 1 part per million of standard hydrogen peroxide with a 5 minute contact time of the standard hydrogen peroxide with the ambient air. The same lab study shows over a 5 log reduction in microbial counts with the photon augmented oxidizing agent solution described in embodiments of this disclosure.

All test samples were compared against the Control provided. (Independent lab testing of the HVAC antimicrobial system utilizing Photon Augmented Oxidizing Agents).

Number of viable cells detected on Control Coupon = 4.9 × 10⁵
Number of viable cells detected on Coupon D4 (#4) = None detected. Represents a 5.7 log 10 kill.
Number of viable cells detected on Coupon D8 (#8) = None detected. Represents a 5.7 log10 kill.

Embodiments of the present disclosure have numerous applications across many industries, from energy storage and production, medical, food, environmental, and others. Embodiments of the method of combining photocatalytic, photochemicallytic (photochemical and photocatalytic), and dissociation reactions with photon-enhanced thermionic emission, MPA, and photon augmented oxidizing agents opens a new frontier. Conventional photocatalysis decomposes oxidizing agents by disproportionation and by promoting oxidizing agent reduction instead of hydrogen liberation. Embodiments of the present disclosure illustrate successful examples of oxidizing agent and water dissociation, wherein trioxygen associates with the reactants and suppresses the reactant reduction, thus promoting hydrogen liberation. Various embodiments of an organic photocatalytic system provide a basis of photocatalytic and photochemical and photocatalytic oxidizing agent and water dissociation. Endogenous x-ray photon production enables the photocatalytic and photochemical dissociation by freeing electrons from the atoms and molecules of the oxidizing agent and water solutions. This reaction can be further enhanced by utilizing x-ray photon reflective materials in the reaction containers or areas.

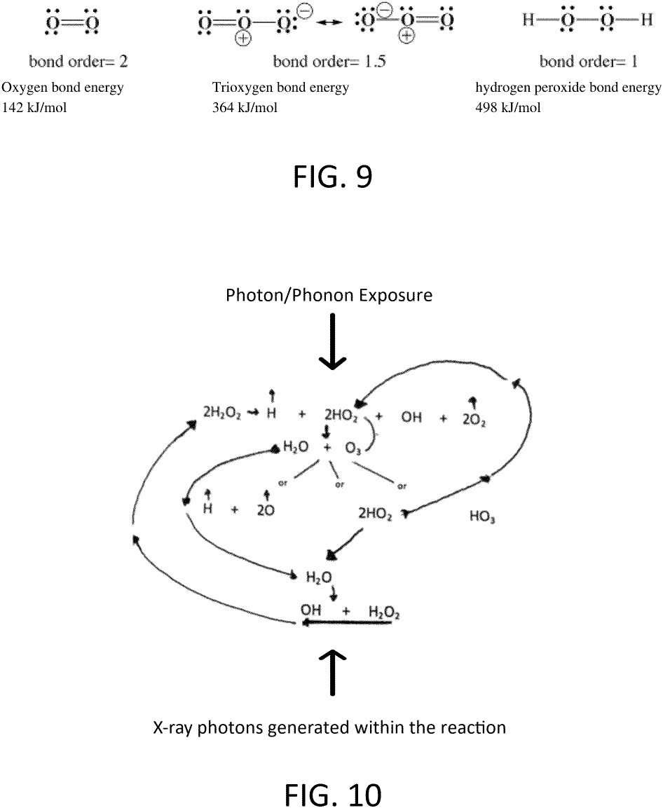

An oxidizing agent is a chemical species that undergoes a chemical reaction in which it gains one or more electrons. Also, an oxidizing agent can be regarded as a chemical species that transfers electronegative atoms, usually oxygen, to a substrate. An example of a common oxidizing agent is hydrogen peroxide. In the photolysis of oxidizing agents such as hydrogen peroxide and ozone, one of the oxygen-oxygen bonds in the molecule breaks. A specific quantity of energy must be added to break the bond. This is the bond energy. Data on bond energies can be obtained experimentally and is readily available on oxidizing agents. Molecular oxygen (O₂) can be photolyzed by light of 241 nm and has a bond energy of 498 kJ/mol. Hydrogen peroxide (HOOH) has a very weak O—O bond and can be photolyzed by light of 845 nm and has a bond energy of only about 142 kJ/mol. The large difference in the strength of oxygen-oxygen bonds in these molecules is due to their Lewis Structures. (FIG. 9).

The bond energy correlates with the bond order. When bond energies are exceeded, ROS, EMODs, hydrogen and its ions, oxygen and its ions, beta particles, hydrons, x-ray photons, and free radicals are released. There are various methods of meeting or exceeding these bond energies discussed herein. Bonds can be broken by exposing oxidizing agents to ionizing photons. These photons can be exogenous but a discovery of new art displayed in this method includes the use of endogenous x-ray photons created when a target atom or molecule is ionized. This creates a hole in an electron shell. The “hole” makes the atom unstable and in an effort to stabilize itself an electron from another shell jumps down to fill the “hole”. The energy the electron must give up to move into the vacant electron hole becomes a x-ray photon. These endogenous created photons continue to break oxygen-oxygen and hydrogen to hydrogen bonds in oxidizing agents creating ROS and EMODs such as hydroxyl radicals. In readily available research, hydroxyl radicals have been shown to exist for only nano-seconds.

The methods and systems disclosed herein demonstrate an increased and prolonged effect of the oxidizing agents that are exposed to photons of 0.01 nm through 845 nm. This prolonged and increased effect can be attributed to the prolonged and increased production of ROS, EMODs, hydrogen and its ions, oxygen and its ions, beta particle, hydrons, x-ray photons, and free radicals when compared to un-augmented oxidizing agents. This effect can be modulated by selecting a container or area that reflects the applied photons back into the augmented oxidizing agent if desired. Since X-rays and visible light are both electromagnetic waves they propagate in space in the same way, but because of the much higher frequency and photon energy of X-rays they interact with matter very differently. Visible light is easily redirected using lenses and mirrors, but because the real part of the complex refractive index of all materials is very close to 1 for X-rays, they instead tend to initially penetrate and eventually get absorbed in most materials without changing direction.

X-rays can be reflected under certain conditions when hitting matter. Mostly three reflection types are distinguished. When x-rays enter matter under grazing incidence, they will be reflected by Total External Reflection (TER) when the angle of incidence is below the critical angle. Crystal surfaces show high reflectivity under special angles depending on the wavelength of the x-rays due to Bragg-reflection. Mirrors using Bragg-reflection to redirect x-rays are called crystal mirrors. These mirrors provide large reflection angles when the reflection condition for a given wavelength is fulfilled. An x-ray mirror can be formed by fabricating a multi-layer system consisting of layers of different index of refraction. The reaction can also be modulated by selecting a container or area that reflects or scatters the endogenous created photons back into the target augmented oxidizing agent if desired.

The prolonged and increased production of ROS, EMODs, hydrogen and its ions, oxygen and its ions, beta particles, hydrons, x-ray photons and free radicals can be modulated by container selection of the photon augmented oxidizing agent. A container that allows photons to easily pass through does not reflect as many endogenous photons and as a result less endogenous x-ray photons are reflected to produce even more endogenous photons. Conversely, a container that reflects or scatters the photons back into the oxidizing agents generates a greater number of endogenous photons on a continuous basis. This amplified effect of the increased ROS, EMODs, hydrogen and its ions, oxygen and its ions, beta particles, hydrons, x-ray photons and free radicals can occur immediately when exogenous photons are applied to the oxidizing agent or an amplified effect of the increased ROS, EMODs, hydrogen and its ions, oxygen and its ions, beta particles, hydrons, x-ray photons and free radical generation can be created at a future time if the augmented oxidizing agent is later placed in a container that reflects or scatters the endogenous photons at a later time.

Ionizing radiation consists of subatomic particles or electromagnetic waves that have sufficient energy to ionize atoms or molecules by detaching electrons from them. Gamma rays, x-rays, and the higher energy ultraviolet part of the electromagnetic spectrum are ionizing radiation, whereas the lower energy ultraviolet, visible light, nearly all types of laser light, infrared, microwaves, and radio waves are typically not thought of as ionizing radiation. Hydrogen peroxide is unique in that the oxygen to oxygen bond is weak. This allows what is normally considered as non-ionizing radiation (845 nm, the upper wavelength that photolyzes oxygen to oxygen bonds in hydrogen peroxide) the ability to detach electrons from atoms or molecules. As mentioned previously, when an electron is removed from an atom or molecule and an electron from a higher orbit takes its place, energy in the form of an x-ray photon is generated and released. We refer to this as an endogenous photon.

Electromagnetic radiations can interact among themselves and with matter, giving rise to a multitude of phenomena such as reflection, refraction, scattering, and polarization. X-ray photons interact with matter through the electrons contained in atoms, which are moving at speeds much slower than light. When the electromagnetic radiation (e.g. x-rays) reaches an electron (a charged particle) it becomes a secondary source of electromagnetic radiation that scatters the incident radiation. According to the wavelength and phase relationships of the scattered radiation, we can refer to elastic processes or Compton scattering, depending on if the wavelength does not change (or changes), and to coherence (or incoherence) if the phase relations are maintained (or not maintained) over time and space. The exchanges of energy and momentum that are produced during these photon and electron interactions can even lead to the expulsion of an electron out of the atom, followed by the occupation of its energy level by electrons located in higher energy levels. Endogenous x-ray photons are generated and released in this process. In the Compton effect, the interaction is inelastic and the radiation loses energy. This phenomenon is always present in the interaction of x-rays with matter. The incoming electrons release x-rays as they slowdown in the target (braking radiation or bremsstrahlung). The x-ray photons produced in this manner range in energy from near zero up to the energy of the electrons.

An incoming electron may also collide with an atom in the target, kicking out an electron and leaving a vacancy in one of the atom’s electron shells. Another electron may fill the vacancy and in so doing release an x-ray photon of a specific energy (a characteristic x-ray) which is scattered relative to the incoming electron. By scattering, we refer here to the changes of direction suffered by the incident radiation. X-ray photons scattered by atoms produce x-ray radiation in all directions, leading to interferences due to the coherent phase differences between the interatomic vectors that describe the relative position of atoms. In a molecule or in an aggregate of atoms, this effect is known as the effect of internal interference, while we refer to an external interference as the effect that occurs between molecules or aggregates.

X-ray photons can be reflected off smooth metallic surfaces at very shallow angles called the grazing incidence. As a means of modulating the amount of scattered radiation, if desired, a x-ray reflecting mirror can be made of glass ceramics which is polished to give a very smooth surface (with root-mean-square surface roughness of a few Angstroms) and is coated with metal for x-ray reflection. A reflection of x-rays can occur off rougher surfaces but loss of x-ray photons through photon absorption and interaction with the reflecting surface occurs. An x-ray photon does reflect off steel, but how much depends on quite a number of factors. For example, what is the angle of the x-ray beam relative to the steel? The x-ray beam will be reflected at different intensities depending on the angle that it hits the steel. So, one can have very different intensities of reflection depending on the angle of incidence relative to the reflected x-ray photon. Another factor to consider is the distance from the x-ray photon source to the steel. The farther away, the weaker the reflection. Another factor is the wavelength (penetrating power) of the x-ray photon. Technically it can be said that a x-ray photon does not reflect, it scatters after interacting with the steel. Some x-ray photons either: penetrate completely thru the steel, are absorbed by the steel or scatter off the steel.

The energy of the x-ray photon will determine how that breaks down. In the methods described herein, the scattered/reflected x-ray photons can be modulated by varying the scattering/ reflectiveness of the surfaces of the container or area containing the photon augmented oxidizing agent. By reflecting endogenous x-ray photons, a photon augmented oxidizing agent can be maintained with a heightened concentration of ROS, EMODs, hydrogen and its ions, oxygen and its ions, beta particles, hydrons, x-rays and other free radicals. This heightened concentration of ROS, EMODs, Hydrogen and its ions, oxygen and its ions beta particles, hydrons, x-rays and other free radicals provides a greater oxidizing potential when compared to an oxidizing agent that has not been augmented with photon emissions. This heightened concentration of ROS, EMODs, hydrogen and its ions, oxygen and its ions, beta particles, hydrons, x-ray photons and other free radicals provides a more effective oxidizing agent and this heightened effectiveness is displayed in the embodiments displayed in the methods of this disclosure.

As used herein, an oxidizing agent can be called an oxygenation reagent or oxygen-atom transfer (OAT) agent. Oxidation reactions may involve oxygen atom transfer reactions and hydrogen atom abstraction which is a reaction where removal of an atom or group from a molecule by a radical occurs. The radiation commonly used in antimicrobial applications, photo-bleaching and other chemical processes is known as UV-C. Ultra-Violet (UV) light is invisible to the human eye and is divided into UV-A, UV-B, and UV-C. UV-C is found within 100-280 nm range. The germicidal action of UV-C is maximized at approximately 265 nm with reductions on either side. UV-C sources typically have their main emission at 254 nm. As a result, germicidal lamps can be effective in breaking down the DNA of microorganisms so that they cannot replicate and cause disease. UV radiation also can be used to eliminate trioxygen which is a Reactive Oxygen Species (ROS). Reactive nitrogen species (RNS) is a subset of reactive oxygen species Trioxygen can be used as a catalyst to convert H₂O to products that exhibit, antimicrobial properties, bleaching properties, etching properties, and other products that have wide commercial uses.

As used herein, photocatalysis is the acceleration of a photoreaction in the presence of a catalyst. Photocatalysts are materials that change the rate of a chemical reaction on exposure to light. In catalyzed photolysis, radiation is absorbed by a substrate. Photocatalytic activity (PCA) depends on the ability of the catalyst to create electron-hole pairs, which utilize electronically modified oxygen derivatives, ROS, hydrogen and its ions, oxygen and its ions, beta particles, hydrons, x-ray photons and other free radicals which are then able to undergo secondary reactions. Typically, two types of photocatalysis reactions are recognized, homogeneous photocatalysis and heterogeneous photocatalysis. As used herein, when both the photocatalyst and the reactant are in the same phase, i.e., gas, solid, or liquid, such photocatalytic reactions are termed as homogeneous photocatalysis. As used herein, when both the photocatalyst and reactant are in different phases, such photocatalytic reactions are classified as heterogeneous photocatalysis. When a photocatalyst is exposed to photon emissions of the desired wavelength (and sufficient energy), the energy of photons may be absorbed by an electron (e⁻) of valence band and it is excited to conduction band. In this process, a hole (h⁺) is created in valence band. This process leads to formation of the photo-excitation state, and a e⁻ and h⁺ pair is generated. A hydroxyl radical is generated in both types of photolysis reactions.

An example of the described reaction used as a bleaching method can be illustrated with the preparation of wood pulp as used in paper manufacturing. One of the largest volume uses of hydrogen peroxide worldwide is pulp bleaching in the paper industry. Hydrogen peroxide is also used to increase the brightness of deinked pulp. The bleaching methods are similar for mechanical pulp in which the goal is to make the fibers brighter. By using various embodiments of the reaction described herein and augmenting the hydrogen peroxide with photons with a wavelength of 0.01 nm through 845 nm, a synergistic reaction takes place generating ROS, EMODs, hydrogen and its ions, beta particles, hydrons, x-ray photons, oxygen and its ions, and other free radicals and also produces photo-oxidation products, photocatalytic products, and/or photochemical products by photon absorption of the oxidizing agent and target, wherein the produced photo oxidation products, photocatalytic products, and/or photochemical products cause a greater bleaching result when compared with the same concentration of un-augmented oxidizing agent in the bleaching process. The methods described herein allow for the same bleaching effect with a lower concentration and or volume of photon augmented oxidizing agent then un-augmented oxidizing agent. According to various embodiments, the self-sustaining circuit of reactions generated with photon AOA, MPA, and PETE permits a reaction that has not been described or utilized with a bleaching reaction previously. In addition, this reaction can be modulated by altering the x-ray photon reflectiveness of the container or area of the described reaction.

Hydrogen peroxide fuel cells have been described in literature. It may be used as an energy carrier to produce electric current. As disclosed herein, PAOA produces more electrical current then hydrogen peroxide that has not been exposed to photons of 0.01 nm through 845 nm.

Hydrogen peroxide is also used widely in the petroleum and petrochemical industries. An example is in the production of plastics. Propylene oxide (PO), an important bulk chemical intermediary, is used for the manufacturing of polyurethanes (polyether polyols), polyesters (propylene glycol) and solvents (propylene glycol ethers). Hydrogen peroxide dissociates generating hydroxyl radicals that react with propylene to form PO. According to various embodiment, the methods described in the present disclosure generate more hydroxyl radicals as explained in this disclosure by exposing hydrogen peroxide to photon emissions of 0.01 nm - - 845 nm wavelengths. This “enhanced” hydrogen peroxide is more reactive in generating PO then un-enhanced (standard) hydrogen peroxide due to the increase in EMODs, ROS, hydrogen and its ions, oxygen and its ions, beta particles, hydrons, endogenous x-ray photons, and other free radicals produced by the methods of this disclosure. The self-sustaining circuit of reactions permits an enhanced reaction that has not been described or utilized when contrasted with common reactions currently utilized in industries like the petroleum/petrochemical industries. The photon AOA and the endogenous generated x-ray photons and endogenous generated beta particles generate a greater reactive potential by creating more ROS, EMODs, hydrogen and its ions, oxygen and its ions, beta particles, hydrons, x-ray photons, and other free radicals when compared to un-augmented hydrogen peroxide that is currently used. The enhanced effect of photon AOA can be modulated by altering the x-ray photon reflectiveness in containers or areas where this reaction takes place.

Hydrogen peroxide (H₂O₂) is commonly used in the dairy industry as an antimicrobial preservative. By enhancing its effectiveness with various embodiments of the methods described in the present disclosure, hydrogen peroxide exposed to photon emissions of 0.01 nm - 845 nm generates more hydroxyl radicals and other EMODs, ROS, hydrogen and its ions, oxygen and its ions, beta particles, hydrons, and endogenous x-ray photons that exert a greater preservative and antimicrobial effect than un-enhanced H₂O₂.

Oxidizing agents are also used in the production of electronics such as microprocessors. By enhancing its effectiveness with various embodiments of the methods described in the present disclosure, hydrogen peroxide and other oxidizing agents exposed to photon emissions of 0.01 nm -845 nm generates more hydroxyl radicals, ROS, hydrogen and its ions, oxygen and its ions, beta particles, hydrons, endogenous x-ray photons, and other EMODs. This allows for a lower concentration of H₂O₂ to provide the required quantity of ROS needed to etch circuit boards and other uses common in the electronics industry.

The list of industries that utilize oxidizing agents and the ROS/EMODs that they provide is extensive. The applications and embodiments described herein are meant to provide examples but are not meant to limit the scope of the disclosure. In addition, a partial list of oxidizing agents includes oxygen (O₂), trioxygen (O₃), hydrogen (H), hydrogen peroxide (H₂O₂), inorganic peroxides, Fenton’s reagent, fluorine (F₂), chlorine (Cl₂), halogens, nitric acid (HNO₃), nitrate compounds, sulfuric acid (H₂SO₄), peroxydisulfuric acid (H₂S₂O₈), peroxymonosulfuric acid (H₂SO₅), sulfur compounds, hypochlorite, chlorite, chlorate, perchlorate, halogen compounds, chromic acid, dichromic acid, chromium trioxide, pyridinium chlorochromate (PCC), chromate, dichromate compounds, hexavalent chromium compounds, potassium permanganate (KMnO₄), sodium perborate, permanganate compounds, nitrous oxide (N₂O), nitrogen dioxide/dinitrogen tetroxide (NO₂ / N₂O₄), urea, potassium nitrate (KNO₃), sodium bismuthate (NaBiO₃), ceric ammonium nitrate, ceric sulfate, cerium (IV) compounds, peracetic acid, and lead dioxide (PbO₂). This list is meant to serve as an example but is not inclusive of all oxidizing agents.

To monitor the synergistic reaction described in the present disclosure, various embodiments include at least one or more sensors or other devices to indicate, detect, or inform of one or more of the following properties of the target or storage or environment: pH, temperature, salinity, density, trioxygen concentration, oxygen concentration, hydrogen concentration, oxidizing agent concentration, flow rate, microbial content, presence or absence of bacterial species, presence or absence of corrosive metabolites or otherwise corrosive substance, identification of a gas, presence or absence of an aqueous environment, presence or absence of high, low, or otherwise concentration of bacterial or non-bacterial, biomass or non-biomass, microbial content, or location of biofilms may be used. This list is not all inclusive but is meant to provide examples of sensors and other devices that may be used singularly or in multiples. According to various embodiments, these sensors may be used to help regulate the reactions described herein.

Temperature affects reaction rate. Some of the reactions described herein are exothermic. A high pH favors hydroxyl radical formation at the expense of trioxygen formation. A low pH favors trioxygen formation over hydroxyl radical production. According to various embodiments, flow rate of the oxidizing agent as it is exposed to exogenous photon emissions is used to influence the effects of the reaction by altering the amount of time substances are exposed to the photons. Also, in various embodiments, flow rate of the oxidizing agent and/or the target of the reaction described herein is used to modulate exposure to variables such as temperature, flow rate, microbes, humidity, and other conditions. This list is not inclusive but is meant as an example of effects of variables.

In some embodiments, variables such as photon emissions dose are used to affect the generation of ROS, EMODs, hydrogen and its ions, oxygen and its ions, beta particles, endogenous x-ray photons, hydrons, and other free radicals. These emissions can be less than 1 second in duration if the intensity and frequency of the photon emissions is high or the time of the applied emissions can be perpetual if the dose or intensity or frequency of the emissions is low. In some embodiments, the temperature of the reaction not only affects the reaction rate but is also used to modulate enzymes present in the reactants. An example of this is the enzyme catalase. Catalase can hinder or stop reactions utilizing oxidizing agents by inactivating hydroxyl radicals. Catalase is inactivated by temperatures above certain limits. By using a sensor to measure temperature and by varying the temperature of the oxidizing agent and or the reactants enzymes such as catalase can have their effects modulated.

According to various embodiments, the photon generating apparatus used in the methods described herein is located in or adjacent to the oxidizing agent to be enhanced. In some instances, the photon generating apparatus is located further from the oxidizing agent and methods of transmission of the photons are utilized. These methods of transmission include fiber optics, reflective materials, and other conductive media.

With an increase in temperature, there is an increase in the number of collisions between reactants. Increasing the concentration of a reactants increases the frequency of collisions between reactants and will, therefore, increase the reaction rate. An increase in temperature corresponds to an increase in the average kinetic energy of the particles in a reacting mixture - the particles move faster, colliding more frequently and with greater energy. Increasing concentration tends to also increase the reaction rate. A decrease in temperature may have the opposite effect when compared to an increase in temperature.

The rate, or speed, at which a reaction occurs depends on the frequency of successful collisions. A successful collision occurs when two reactants collide with enough energy and with the right orientation. That means if there is an increase in the number of collisions, an increase in the number of particles that have enough energy to react, and/or an increase in the number of particles with the correct orientation, the rate of reaction will increase. MPA is an example of the effects of increased collisions associated with this disclosure.

The rate of reaction is related to terms of three factors: collision frequency, collision energy, and geometric orientation. The collision frequency is dependent, among other factors, on the temperature of the reaction. When the temperature is increased, the average velocity of the particles is increased. The average kinetic energy of these particles is also increased. The result is that the particles will collide more frequently, because the particles move around faster and will encounter more reactant particles. However, this is only a minor part of the reason why the rate is increased. Just because the particles are colliding more frequently does not mean that the reaction will occur. The availability of beta particles, ionizing photons and the x-ray photon reflectivity off of containers and areas also plays an integral part in this disclosure.

Another effect of increasing the temperature is that more of the particles that collide will have the amount of energy needed to have an effective collision. In other words, more particles will have the necessary activation energy. For example, at room temperature, the hydrogen and oxygen in the atmosphere do not have sufficient energy to attain the activation energy needed to produce water:

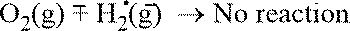

At any one moment in the atmosphere, there are many collisions occurring between these two reactants. But what we find is that water is not formed from the oxygen and hydrogen molecules colliding in the atmosphere, because the activation energy barrier is just too high, and all the collisions are resulting in rebound. When we increase the temperature of the reactants or give them energy in some other way, the molecules have the necessary activation energy and are able to react to produce water:

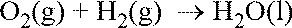

In various embodiments, the rate of a reaction is slowed down. In some embodiments, lowering the temperature is used to decrease the number of collisions that would occur and lowering the temperature would also reduce the kinetic energy available for activation energy. If the particles have insufficient activation energy, the collisions will result in rebound rather than reaction. Using this idea, when the rate of a reaction needs to be lower, keeping the particles from having sufficient activation energy will keep the reaction at a lower rate.

In various embodiments, the humidity where the reactions described herein takes place affects the evaporation rate of the droplet if the desired location of the reaction is in the air. This variable, humidity, can change the rate of evaporation if the humidity is high and cause a decrease in the evaporation rate or cause an increase in the evaporation rate if the humidity is low in the area where the reactions described herein is to take place.

In various embodiments, where the reactions described herein take place in a liquid or gaseous environment, the opacity of the liquid or gas affects the reaction rate. In some embodiments, the more opaque a liquid or gas is, a higher dose of photons is required to achieve the desired reaction rate due to the opacity of the medium and its ability to affect interactions of the photon emissions with target materials such as oxidizing agents. Likewise, in some embodiments, the viscosity of the medium where the described reaction takes place influences the reaction rate. In some embodiments, a higher viscosity medium retards the reaction rate due to the loss of photon energy as the photons move through the medium. In other embodiments, a lower viscosity medium causes the photons to lose less energy as they move through the medium.

In some embodiments, the reactions described herein have an increased reaction rate with the addition of a catalyst. For example, iron oxides catalyze the conversion of hydrogen peroxide into oxidants capable of transforming recalcitrant contaminants. This is an example of an additive effect of a catalyst.

In some embodiments, it is desirable to slow down or halt the described reaction. For example, peroxidases or peroxide reductases are a group of enzymes which play a role in various chemical processes. They are named after the fact that they commonly break up peroxides.

Flocculants, also known as clarifying agents, are used to remove suspended solids from liquids by inducing flocculation. The solids begin to aggregate forming flakes, which either precipitate to the bottom or float to the surface of the liquid, and then they can be removed or collected. According to various embodiments, flocculants are added to the reactions described herein before during or after the photon enhanced oxidizing agent is applied to the target where the described reaction is to take place. In some embodiments, flocculants are added before the reaction to remove substances that are not desired to undergo the described reaction. In other embodiments, the flocculant is added during the reaction or after the reaction depending on the desired outcome and use of the precipitated substance.

FIG. 10 is an exemplary diagram showing that a reaction can occur from a reactant molecule via an intermediate such as hydroperoxyl to form a trioxygen molecule. FIG. 10 also shows an exemplary diagram showing a “stored” oxidizing effect that can be tapped to provide reactive oxygen species, EMODs, hydrogen and its ions, oxygen and its ions, beta particles, hydrons, endogenous x-ray photons, and other free radicals as needed, and the “stored” oxidizing effect feeds the self-sustained circuit of reactions so that reactive oxygen species, EMODs, hydrogen and its ions, oxygen and its ions, beta particles, hydrons, endogenous x-ray photons, and other free radicals are generated until one of the reactants is depleted. During its decay back to the ground state, the trioxygen molecule created in the described reaction emits energy. This released energy provides endogenous photons and other reactants such as beta particles, electrons and hydrons to help power the continuing self-sustaining circuit of reactions.

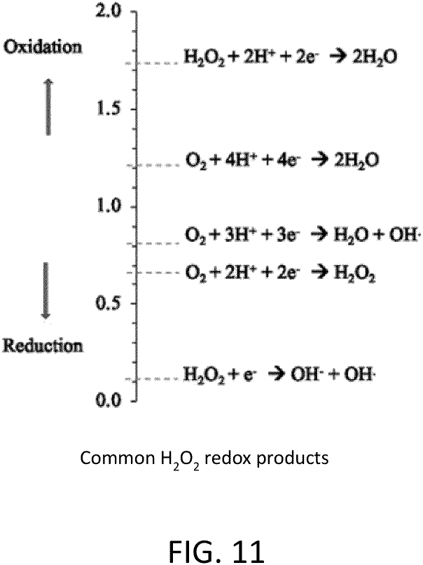

FIG. 11 is

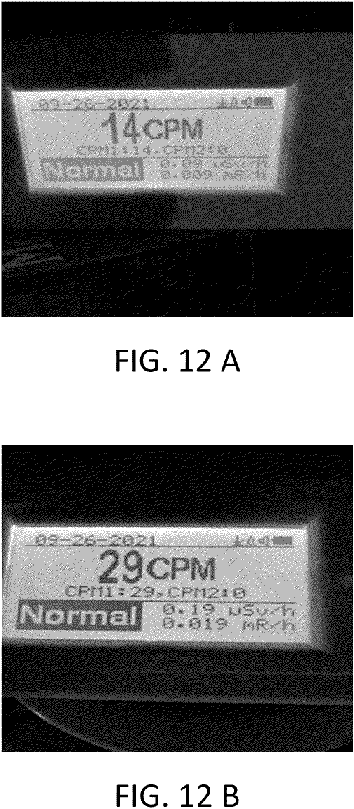

Photons of 0.01 nm through 845 nm emitted on water and hydrogen peroxide creates the reaction illustrated in FIG. 10. Once the reaction is initiated, the reaction proceeds with or without further addition of photons from an outside exogenous source. The products such as ROS, beta particles, hydrons, trioxygen, hydrogen and its ions, oxygen and its ions, and other generated electronically modified oxygen derivatives continue to “power” the reaction along with endogenous generated x-ray photons. An example of these products contributing to the continued reaction can be found in the decay of trioxygen. As it decays, x-ray photons are produced releasing energy to the reaction. As shown by the photos in FIGS. 12A and 12B, the increased reaction potential of the photon AOA reaction can be registered on a Geiger Counter.

The photo in FIG. 12A records the Geiger Counter count from hydrogen peroxide that has not been exposed to photon and or phonons. The photo in FIG. 12B shows the Geiger Counter count from hydrogen peroxide that has been exposed to photons from 0.01 nm - 845 nm as described by the an embodiment of the methods in the present disclosure.

The x-ray photons created by the methods described herein are displayed as the increased CPM count (14 CPM to 29 CPM). The elevated CPM count is evident for days after the initial exogenous photon exposure of the hydrogen peroxide. Since x-ray photons are transient in nature, this sustained elevated CPM reading can only be explained by the self-sustaining circuit of reactions described in this disclosure. The elevated CPM reading displays an increase in endogenous x-ray photons from the self-sustaining circuit of reactions described in this disclosure. As discussed previously herein, this effect can be modulated by increasing the x-ray reflectiveness of the reaction container or area.

Table 2 illustrates the enhanced effectiveness produced by an embodiment of the reactions illustrated in FIG. 10. The control substance, which is hydrogen peroxide that has not been exposed to exogenous photon emissions from 0.01 nm - 845 nm as described in this disclosure, exhibited a 23.08% microbial ( E. coli) reduction while the two samples of the photon augmented solution (Sample 1 and Sample 2a) displayed a heightened effectiveness ranging between 76.92 % and 84.62% microbial reduction at 4 weeks post exposure to radiation of 0.01 nm through 845 nm.

This heightened residual effect supports the claim of continuing self-sustaining circuit of reactions described in this disclosure.

TABLE 2

| Test Microorganism | Contact Time | Test Substance | Replicate | CFU/Carrier | Average Percent Reduction Compared to Controls | Average Log₁₀ Reduction Compared to Controls |
|---|---|---|---|---|---|---|
| E. coli ATCC 11229 | Pre-Treatment | Numbers Control | 1 | 3.90E+04 | N/A | N/A |
| | 10 Minutes | Control Substance | 1 | 3.00E+04 | 23.08% | 0.11 |
| | | Sample 1 | 1 | 6.00E+03 | 84.62% | 0.81 |
| | | Sample 2a | 1 | 9.00E+03 | 76.92% | 0.64 |

Various embodiments of the present disclosure relate to producing one or more of trioxygen, hydrogen and/or its isotopes, oxygen and/or its isotopes, and/or electronically modified oxygen derivatives, reactive oxygen species, hydrons, free radicals, oxidizing molecules, oxygen-atom transfer (OAT) agents, oxidizing agents and/or various related species from oxidizing agents that are exposed to certain wavelengths of photon emission, exposed for certain amounts of time and exposed to certain intensities of photon emission. In various embodiments, the oxidizing agents are exposed to multiple frequencies of photon emission and multiple exposures of photon emission. In embodiments, the photons are supplied to the oxidizing agents continuously or in bursts or pulses. A continuous photon emission could be, for example, from a light emitting diode suspended in a container of an oxidizing agent emitting a constant dose of photons. Bursts or pulses of photon emission could be utilized to rapidly enhance an oxidizing agent with 0.01 nm - 845 nm photon, for example from a high intensity laser where the high intensity bursts or pulses may be only seconds in duration, but these bursts or pulses could provide the same dose of photon emissions as a long duration continuous photon emission that was at a low dose, where dose is defined as intensity of the photon emission times the time of application.

The present disclosure describes research into utilizing the effects of ionizing photons on oxidizing agents, and a discovery that offers a revolutionary and multi-disciplinary advancement to science. The disclosed methods provide a new paradigm to perform photocatalytic oxidation of substrates using selected photon emission as energy input, generating endogenous x-ray photons, and endogenous beta particles, trioxygen, hydrons, oxygen and its ions, and/or hydrogen and its ions as the catalysts, oxidizing agents as the oxygen source, and dissociation reactions to minimize hindrances to the reactions.

Photocatalytic activity (PCA) is commonly applied to a target where the desired reaction is to take place in two distinct ways. Various embodiments of the present disclosure utilize both methods of applying photocatalytic activity to generate unique reactions that continue even after the initial photon emissions that initiates the PCA is discontinued. As detailed in the present disclosure, it has been found that the destruction of trioxygen (O₃) by certain wavelengths of photon emission prevents or retards reactions involved in the photocatalytic effects described herein. The catalyst, trioxygen, was being eliminated by certain wavelengths of photons that encourage dissociation of trioxygen. By altering the production or availability of trioxygen, according to described embodiments, the displayed reactions include steps that allow and encourage, or alternatively prevent or retard the generation of products such as oxygen and its ions, hydrogen and its ions, hydron, reactive nitrogen species, electronically modified oxygen derivatives (EMODS), beta particles, endogenous x-ray photons and others. Some examples of EMODs are superoxide, hydrogen peroxide, hydroxyl radical, hydroxyl ion, and nitric oxide.

These EMODs are generated by exposing oxidizing agents to photons of a certain wavelength, for example between 0.01 nm and 845 nm, where the interaction of these agents, oxidizing agents and radiation, when combined produce a total effect that is greater than the sum of the effects of the individual agents. This photon exposure generates EMODs, ROS, hydrogen and its ions, oxygen and its ions, beta particles, hydrons, endogenous x-ray photons and other free radicals. These have effects that exist for longer than typically found in nature by evidence of a residual effect created by the self-sustaining circuit of reactions which, displayed in Table 2, has shown as an increased effect that lasts for days, thereby providing a photon Augmented Oxidizing Agent (AOA) that has increased oxidizing potential when compared with the same oxidizing agent that has not been augmented with photons as described in the disclosure.

The expected life span of EMODs, ROS, hydrogen and its ions, oxygen and its ions, beta particles, hydrons, endogenous x-ray photons and other free radicals when they are found naturally in nature is measured in nanoseconds. Exposing oxidizing agents to photons as described in this disclosure produces a photon AOA having a unique concentration of EMOD, ROS, hydrogen and its ions, oxygen and its ions, beta particles, hydrons, endogenous x-ray photons and other free radicals that exhibits a residual effect demonstrated by its existence for hours, days, weeks, and greater extended periods of time. As previously stated, this is evident due to the endogenous generated x-ray photons and the endogenous generated beta particles and hydrons which have previously been unreported or unrecognized. In various embodiments, the photon wavelength in a range of 0.01 nm to 845 nm is produced from a variety of sources such as x-ray generators, LEDs, lasers, natural light, electromagnetic radiation, arc lamps and other suitable sources. The list of radiation producing sources is not meant to limit sources to those listed but to serve as an example.

Table 3 shows actual testing results that illustrate the residual effect of photon AOAs containing EMODs, ROS, hydrogen and its ions, oxygen its ions, beta particle, endogenous x-ray photons, hydrons and other free radicals created by embodiments of the present disclosure. The test substance was a solution of 3% hydrogen peroxide, which was exposed to photons to form the AOA containing EMODs, ROS, hydrogen and its ions, oxygen and its ions, beta particles, hydrons, x-ray photons, and other free radicals. The test substance or photon AOA was applied to a target which was a microbe inoculated agar plate.

According to various embodiments, the application of the photon AOA can be by a dropper, fog, mist or spray or any other acceptable means. This list is not meant to limit the application but to illustrate possible applications of the photon AOA to the inoculum which had been placed on a carrier (e.g. agar) with a viable bacteria concentration of anaerobic bacteria Staphylococcus epidermidis ATCC 12228. A control sample of an inoculated agar plate that had hydrogen peroxide that had not been augmented with photons as described in this disclosure applied to it was also tested. Photon AOA was applied to inoculated plates at intervals of 1 minute, 5 minutes, 10 minutes, 30 minutes, 1 hour, 12 hours, 24 hours, 2, days, 5 days, and 7 days after radiation exposure. In one test, after 7 days, the photon AOAwas again subjected to photon emissions from 0.01 nm to 845 nm for the test labeled reactivation. An additional photon and or phonon exposure similar to the initial augmentation by photon and or phonons of 0.01 nm through 845 nm was the reactivation dose of photons.

TABLE 3

| | | | | | |
|---|---|---|---|---|---|
| Microorganism | Test Substance Concentration | Time After Radiation Exposure Substance Applied to Carrier | CFU/carrier | Percent Reduction vs. Parallel Control | Log10 Reduction vs. Parallel Control |
| S. epidermidis ATCC 12228 | Control 3% H₂O₂ | N/A 1 Minute 5 Minute 10 Minute 30 Minute 1 Hour | 6.04E+05 7.00E+04 7.00E+04 3.10E+04 2.80E+04 7.10E+04 | N/A 88.42% 88.42% 94.87% 95.37% 88.25% | N/A 0.94 0.94 1.29 1.33 0.93 |
| | Control 3% H₂O₂ | 12 Hours | 9.20E+04 1.80E+04 | N/A 80.43% | N/A 0.71 |
| | Control 3% H₂O₂ | 24 Hours | 1.33E+05 2.10E+04 | N/A 84.21 % | N/A 0.80 |
| | Control 3% H₂O₂ | 2 Days | 3.00E+05 9.00E+04 | N/A 70.00% | N/A 0.52 |
| | Control 3% H₂O₂ | 5 Days | 4.50E+04 3.29E+03 | N/A 92.69% | N/A 1.14 |
| | Control 3% H₂O₂ 7 Days w/ Reactivation | 7 Days | 9.80E+04 1.50E+04 1.00E+04 | N/A 84.69% 89.80% | N/A 0.82 0.99 |

There are statistical testing variations but when comparing the increased activation of the photon AOAs at 1 minute post augmentation with photon AOA that was augmented 7 days previously, the results are very similar. The photon AOA exhibits a pronounced residual effect. This residual effect is evidenced by the antimicrobial heightened effect of the photon AOAs in reducing the microbial count. The un-augmented oxidizing agents have been shown to exhibit an antimicrobial effect of approximately 30% at a dwell time of 5 minutes. A dose of photon exposure between 0.01 nm through 845 nm that has been applied to a agar plate with a known quantity of microbes has been shown to kill approximately 1% of the microbes that are exposed to it for 5 minutes. This 1% inactivation occurs solely from the 0.01 nm through 845 nm photon exposure. No oxidizing agent has been added.

The above refers to the effects of un-augmented oxidizing agents on microbes and contrasts sharply with the greater antimicrobial effect of photon AOA. The photon AOAs demonstrate an antimicrobial effect over 100% greater than un-augmented oxidizing agents as displayed in Table 4. The enhanced microbial reduction achieved by augmenting the oxidizing agent with a photon exposure from 0.01 nm through 845 nm is over a 5-log reduction in the microbial count. This effect provides a concentration of a photon AOA with over double the antimicrobial effect when compared to un-augmented oxidizing agents. Also, a concentration of photon AOA can be utilized that is 50% or less of the concentration of the un-augmented oxidizing agent and exhibit the same antimicrobial activity.

Table 4 shows additional testing results that illustrate the residual effect of photon AOAs containing EMODs, ROS, hydrogen and its ions, oxygen and its ions, beta particles, hydrons, endogenous x-ray photons, and other free radicals created by embodiments of the present disclosure. The test substances were hydrogen peroxide at 1 ppm and at 0.3%, which were exposed or not exposed to photons of 0.01 nm through 845 nm and applied to target of microbes, which included a carrier for the inoculated target microbes such as agar with a viable bacteria concentration of Staphylococcus aureus ATCC 6538. The control for this test was a similar inoculated plate and it was treated in the same manor but there was no application of photons to the oxidizing agent.

TABLE 4

| Test Microorganism | Contact Time | Test Substance | Replicate | CFU/ml | Average CFU/ml | Average Percent Reduction Compared to Controls | Average Log₁₀ Reduction Compared to Controls |
|---|---|---|---|---|---|---|---|
| S. aureus ATCC 6538 | PreTreatment | Numbers Control | 1 | 3.32E+06 | 3.43E+06 | N/A | N/A |
| | | | 2 | 2.90E+06 | | | |
| | PostTreatment | Numbers Control | 1 | 3.90E+06 | | | |
| | | | 2 | 3.60E+06 | | | |
| | 5 Minutes | 1 PPM No photon emission | 1 | 4.10E+06 | 4.05E+06 | No Reduction | No Reduction |
| | | | 2 | 4.10E+06 | | | |
| | | 0.3% No photon emission | 1 | 4.10E+06 | 4.05E+06 | No Reduction | No Reduction |
| | | | 2 | 4.00E+06 | | | |
| | | 1 PPM Treated with photons | 1 | <1.00E+01 | <1.00E+01 | >99.9997% | >5.54 |
| | | | 2 | <1.00E+01 | | | |
| | | 0.3% Treated with photons | 1 | <1.00E+01 | <1.00E+01 | >99.9997% | >5.54 |
| | | | 2 | <1.00E+01 | | | |

In an exemplary embodiment, it is understood that after trioxygen is produced it will decay rapidly, because trioxygen is an unstable compound with a relatively short half-life. The half-life of trioxygen in liquid is shorter than in air. Trioxygen decays in liquids partly in reactions with hydroxyl radicals. The assessment of a trioxygen decay process involves the reactions of two species: trioxygen and hydroxyl radicals. Trioxygen generated by the methods of this disclosure decays but the reactions of produced endogenous x-ray photons and endogenous beta particles and hydrons react with the water and oxidizing agent sample to continue to generate trioxygen, ROS, EMODs, hydrogen and its ions, oxygen and its ions, beta particles, hydrons, endogenous x-ray photons and other free radicals. This continued generation of trioxygen, ROS, EMODs, hydrogen and its ions, oxygen and its ions, beta particles, hydrons, endogenous x-ray photons and other free radicals is a distinct advantage over current methods and is the reason for the extended and heightened effects of the photon AOA displayed in this disclosure.

According to various embodiments, the decay of trioxygen in contact with hydroxyl radicals is characterized by a fast initial decrease of trioxygen, followed by a second phase in which trioxygen decreases by first order kinetics. In various embodiments, dependent on the composition of the liquids, the half-life of trioxygen is in the range of seconds to hours. In various embodiments, factors influencing the decomposition of trioxygen in liquids are temperature, pH, ions, cations, environment, concentrations of dissolved matter, beta particles, hydrons and photon emissions. As disclosed above, trioxygen decomposes partly in the presence of hydroxyl radicals. In various embodiments, when the pH value increases, the formation of hydroxyl radicals increases in a substance. In a solution with a high pH value, there are more hydroxide ions present, see Reaction 1 and Reaction 2. These hydroxide ions act as an initiator for the decay of trioxygen:

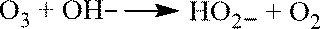

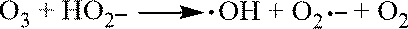

In further exemplary embodiments, oxidative reactions due to photocatalytic, homogenous effects are described and utilized as follows:

The mechanism of hydroxyl radical production follow paths such as:

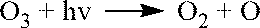

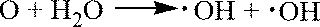

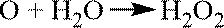

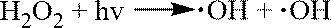

Similarly, the Fenton system produces hydroxyl radicals by the following mechanism:

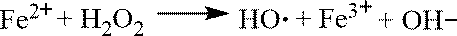

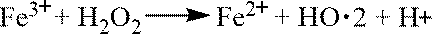

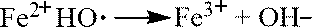

In photo-Fenton type processes, additional sources of OH radicals are considered: through photolysis of H₂O₂, and through reduction of Fe³⁺ ions under photon excitation:

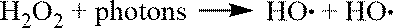

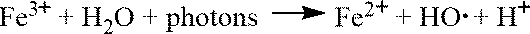

Oxidative reactions due to photocatalytic heterogenous effect:

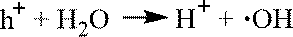

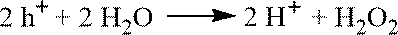

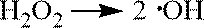

The reaction of H₂O₂ = H₂O + O is typically referenced in literature as the predominant disassociation reaction associated with hydrogen peroxide and results in the production of oxygen and water. There are several reaction pathways in addition to the basic “hydrogen peroxide dissociates into water and oxygen” such as dissociation to hydronium ion and hydroperoxide, and disproportionation to dioxygen and water. Note that trioxygen is not produced in the above reactions.

According to various embodiments, trioxygen is photo-dissociated by certain wavelengths of photon emissions. In various embodiments, while trioxygen is created, it is also dissociated depending on the desired outcome of the reaction. Table 5 is a partial list of the products of trioxygen dissociation, and a partial list of the wavelengths associated with those products.

TABLE 5

| | |
|---|---|
| O(³P) + O₂(³∑) | 1118 nm - 1119 nm |
| O(³P) + O₂(¹Δ) | 599 nm - 600 nm |
| O(³P) + O₂(¹∑) | 452 nm - 453 nm |
| O(¹D) + O₂(³∑) | 402 nm - 403 nm |
| O(¹D) + O₂(¹Δ) | 307 nm - 308 nm |
| O(¹D) + O₂(¹∑) | 263 nm - 264 nm |
| O(³P) + O(³P) + O(³P) | 197 nm - 198 nm |

According to various embodiments, in one path, the embodiments describe one or more reactions whereby the trioxygen is not totally dissociated or is partially dissociated by photon emissions. Trioxygen then becomes a photocatalyst for new reactions. In various embodiments, trioxygen is produced and retained when the wavelengths of photodissociation (e.g., Table 4) are excluded or the dose of this radiation is reduced. This exclusion or reduction coupled with photocatalytic reactions generating one or more of reactive nitrogen species, trioxygen, hydrogen and/or its isotopes, oxygen and/or its isotopes, electronically modified oxygen derivatives, reactive oxygen species, hydrons, free radicals, oxidizing molecules, oxidizing agents, beta particles, endogenous x-ray photons, and/or various related species from oxidizing agents that are exposed to certain frequencies of photon emissions creates photon AOA. In various embodiments, the reaction with OH- is the initial decomposition step of trioxygen decay, the stability of a trioxygen solution is thus dependent on pH and decreases as alkalinity rises. In various embodiments, at pH above 8 the initiation rate, in the presence of radical scavengers, is generally proportional to the concentrations of trioxygen and OH—. In other embodiments, in acidic solutions the reaction with OH— is not the initiation step. Predicted reaction rates below pH 4 including a mechanism based only on reaction with OH— are much lower than those determined experimentally. The trioxygen equilibrium reaction below becomes significant and the initiation reaction is catalyzed.

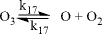

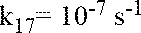

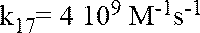

The atomic O continues to react with H₂O, or forms an excited trioxygen radical, from recombination, that subsequently reacts with H₂O, as shown in the two equations below, respectively.

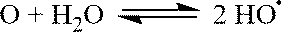

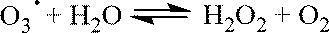

In various embodiments, the species formed then react further, forming other radicals such as O₂—/HO₂. The propagating products, HO• and HO₂, diffuse and react with trioxygen in the continuing self-sustaining circuit of reactions that is initiated with photon emissions of 0.01 nm to 845 nm. In addition, the endogenous x-ray photons and the endogenous beta particles and hydrons are part of the fuel that continues the self-sustaining circuit of reactions described in this disclosure.

An example of an oxidizing agent involved in this reaction: H₂O₂ + photon emissions from 0.01 nm to 845 nm. When H₂O₂ and this selective photon emission are combined, this reaction yields H₂ + 2HO₂ which in turn yields H₂O + trioxygen. In various embodiments, this self-sustaining circuit of reactions will continue as long as the correct wavelength of exogenous or endogenous photons are present. Also, this self-sustaining circuit of reactions can proceed without the exogenous addition of photons if endogenous x-ray photons, endogenous beta particles, hydrons and other produced reactants are present and H₂O₂ (oxidizing agent) is present. In various embodiments, the two paths of this reaction yield various products but particularly H₂ and O₂ or yield 2HO₂.

In some embodiments, the trioxygen that is created on this path enters and exists in this self-sustaining circuit of reactions with H₂O. The self-sustaining circuit of reactions continue to function and is partially supported by the supply of trioxygen or hydroperoxyls generated from reactions of trioxygen or hydroxyl radicals or generated from reactions of trioxygen with other reactants by the interactions of exogenous and endogenous photons and endogenous beta particles and hydrons. In various embodiments, a self-sustaining circuit of reactions includes numerous reactions and potential reactions that vary depending on variables such as temperature, pH, catalysts, and others. One of the displayed reactions in the self-sustaining circuit of reactions is exogenous and endogenous photon emissions reacting with trioxygen and water producing at various stages O2, hydroxyls, H₂, HO₃, HO₄, hydrons and hydroperoxyls.

Exposure of oxidizing agents such as hydrogen peroxide with the entire UV spectrum of radiation produces hydroxyl radicals but limited trioxygen due to the wavelengths that are present that also destroy trioxygen. This dissociation of trioxygen was previously unappreciated and, without recognizing this and including exogenous and endogenous photon exposure, the products of this reaction will not be produced in sufficient quantities to produce a self-sustaining circuit of reactions. Furthermore, if the steps of this disclosure are performed, but performed in the wrong sequence, the reaction will not have the desired results and the self-sustaining chain of reactions will not occur. Hydroxyl radicals are very reactive free radicals, but they only exist for extremely brief periods of time measured in nanoseconds. This nanosecond long existence leads to a short-term effect whereby the hydroxyl radicals exert an influence that cannot be stored or held in reserve.

Various embodiments of this disclosure are directed to utilizing exogenous and endogenous photon emissions of 0.01 nm through 845 nm to free electrons from atoms and molecules. The ROS, EMODs, hydrogen and its ions, oxygen and its ions, beta particles, hydrons, endogenous x-ray photons, and other free radicals created form a self-sustaining circuit of reactions that has an increased oxidation potential when compared to oxidizing agents that have not been exposed to the same photon emissions. The increased potential of the photon Augmented Oxidizing Agents allows for a higher effectiveness of the oxidizing potential (as evidenced by the research studies included in this disclosure) that also is evident for a period of time even after the exogenous photon emissions to the oxidizing agents have been stopped. This increased effectiveness over time is due to the endogenous x-ray photon emissions produced by the methods of this disclosure.

This endogenous photon emission can be modulated by altering the x-ray photon reflectiveness in the container or in the area of the disclosed reaction. X-ray and gamma ray photons, which are at the upper end of electromagnetic spectrum, have very high frequencies and very short wavelengths. Photons in this range have high energy. They have enough energy to strip electrons from an atom or, in the case of very high-energy photons, break up the nucleus of the atom. Each ionization releases energy that is absorbed or reflected or scattered by material/matter surrounding the ionized atom. Ionizing radiation deposits a large amount of energy into a small area. In fact, the energy from one ionization is more than enough energy to disrupt the chemical bond (oxidation) between two atoms. The self-sustaining circuit of reactions displayed in this disclosure is new art which produces an increased and prolonged oxidative ability of oxidizing agent reactions that may be utilized advantageously in science and industry.

According to various embodiments, the production of ROS, EMODs, hydrogen and its ions, beta particles, endogenous x-ray photons, oxygen and its ions, hydrons and other free radicals generated by the photon emissions of certain wavelengths of 0.01 nm through 845 nm and interaction with oxidizing agents, produces an increased concentration of reactants such as hydroperoxyls that react to form trioxygen, EMODs, ROS, hydrogen and its ions, oxygen and its ions, beta particles, hydrons, trioxidane, endogenous x-ray photons, and other free radicals. With exogenous and endogenous photon emissions in a self-sustaining circuit of reactions, a steady stream of reaction products is created, one being a chain of hydroxyl radicals that can now exert a more long-lasting effect due to their continued and heightened production. In various embodiments, this self-sustaining circuit of reactions allows for a “shelf life” where the reaction is maintained and stored for future use even after the exogenous photon exposure to the oxidizing agent has been terminated. In disclosed embodiments, the increased effects and efficiencies in the oxidizing ability of the PAOA that can now be measured in minutes, hours, or days due to the continued effect of the reaction products created by the self-sustaining circuit of reactions. This increased effectiveness is evident when comparing PAOA with oxidizing agents that have not been exposed to photon emissions as discussed in this disclosure.

According to various embodiments, in reference to the disclosed reactions, the embodiments described herein explain new discoveries whereby the photon emissions directed at the oxidizing agent or oxidizing agents alters the typical standard oxidation potential of oxidizing agents which is the tendency for a species to be oxidized at standard conditions. Oxidation is defined as a process in which an electron is removed from a molecule during a chemical reaction. During oxidation, there is a transfer of electrons or there is a loss of electrons.

The following embodiment relates to a working model of the equation for the self-sustaining circuit of reactions. In chemical kinetics, an equation dictates that a chemical reaction utilizing oxidizing agents proceeds via a decomposition reaction where an electron induced decomposition by photons (that may exclude wavelengths inhibiting trioxygen formation or destroying trioxygen) of the oxidizing agent proceeds. X defines potential decomposition by-products such as reactive nitrogen species, hydroxyls, hydroperoxyls, electronically modified oxygen species, hydrogen, oxygen, hydrons, and others. In various embodiments, a reaction occurs from a reactant molecule via an intermediate such as hydroperoxyl to form a trioxygen molecule, as shown below.

$$\begin{matrix}\text{OXIDIZING AGENT + photon dose} \\ {\text{(excluding wavelengths that dissociate trioxygen (O}}_{3} ) ) \to {\text{O}}_{3} + \text{X} \text{.}\end{matrix}$$

In reference to the above reactions, this embodiment explains discoveries whereby the photon emissions of 0.01 nm through 845 nm directed at the oxidizing agent alters the typical reaction. In various embodiments, this may be accomplished by excluding wavelengths of photons that inhibit the formation of trioxygen or wavelengths that destroy trioxygen.

Photochemical reactions are a chemical reaction initiated by the absorption of energy in the form of photons. A consequence of molecules absorbing photons is the creation of transient excited states whose chemical and physical properties differ greatly from the original molecules. According to various embodiments, photochemical reactions combined with photocatalytic trioxygen generation (PTG) splits water molecules into hydrons, H₂, O₂, and O₃. PTG can achieve high dissolution in water without other competing gases found in the corona discharge method of trioxygen production, such as nitrogen gases present in ambient air. In various embodiments, this method of generation achieves consistent trioxygen concentration and is independent of air quality because water is used as the source material. Production of trioxygen photochemically was previously not utilized in reactions such as those described in the present disclosure because the required photon wavelength exclusion required to produce trioxygen as compared to producing oxygen as the typical reaction product was not understood or was underappreciated. However, as described herein, in various embodiments it is possible to change the production of oxygen by careful selection of photon wavelengths and pH such that trioxygen is preferentially produced.

Previous research involving UV radiation utilized bulbs (devices emitting electromagnetic energy) that produced a bell-shaped curve of radiation that produced wavelengths of dissociation of compounds and wavelengths creating the same compounds. While there may have been a greater influence of either the creation or dissociation wavelength, the resulting reaction was inefficient.

Thus, in various embodiments of the present disclosure, to generate more trioxygen, photochemical reactions combined with PTG, where wavelengths of photons that dissociate trioxygen are excluded, the dose of photon emission is increased by increasing the frequency, intensity, the time the photon emission is applied, and other variables, to the dose where some or all variables may be changed to influence the result of the reaction. This demonstrates the nature of the initial complex which decomposes an oxidizing agent upon photon exposure as described in this disclosure.

Further, in various embodiments, multiple reaction sequences are possible. First, comparing the electronic structure of the water and the oxidizing agent molecules, the trioxygen cleaves at least one oxygen-hydrogen bond of the water molecule in a self-sustaining circuit of reactions, which in turn, forms a hydroxyl radical plus atomic hydrogen. In various embodiments, two of the hydroxyl radicals recombine in an exoergic reaction to form an oxidizing agent molecule. The reaction reversibility dictates that upon application of trioxygen to the water molecule, the latter can decompose in one step to form oxygen atoms plus molecular hydrogen. In various embodiments, the oxygen atom in the presence of trioxygen reacts now with a water molecule by an insertion into an oxygen-hydrogen bond to form hydrogen peroxide but with the continued application of trioxygen, the generation of H₂O₂ is delayed or excluded. As the reaction is delayed, oxygen and hydrogen are liberated in sufficient quantities to alter the quantity of available components, thus preventing or minimizing the production of H₂O₂. Alternatively, in various embodiments, the oxygen atom adds itself to the oxygen atom of the water molecule forming a short-lived intermediate which then rearranges via hydrogen migration to a hydrogen peroxide molecule. The following equations display an electron induced decomposition of two water molecules in proximity (H₂O(X¹A₁))₂ to form a hydrogen peroxide molecule while liberating hydrogen and oxygen

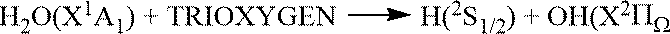

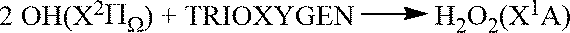

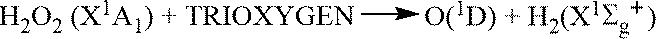

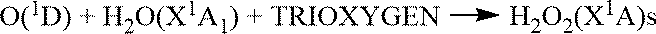

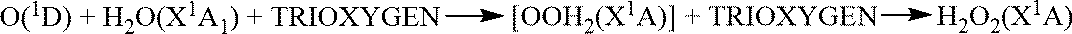

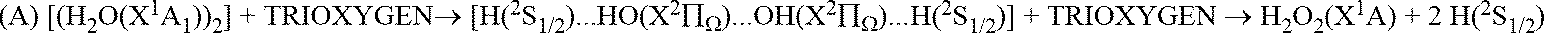

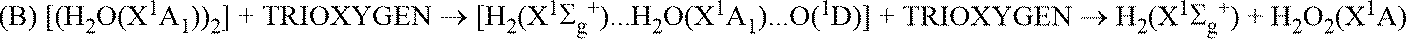

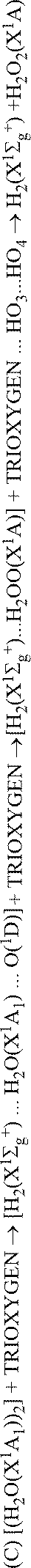

As can be seen above from the equations, the water solution still stores highly reactive radicals such as RNS, EMODs, hydroxyl radicals, hydroperoxyls, hydrogen and its ions, oxygen and its ions, hydrons, and the like. In various embodiments, hydroxyl radicals diffuse and once they encounter a second hydroxyl radical, they recombine to form hydrogen peroxide. As described herein, it is understood that upon decomposition of water molecules, oxygen atoms are formed in a first excited state. The reactivity of ground state atoms with water is different compared to the dynamics of the trioxygen excited counterparts generated during exposure to trioxygen described in the present disclosure via the stated equations.

The data and related discussion on the formation of the hydrogen peroxide molecule also explain the synthesis of atomic and molecular hydrogen during the trioxygen exposure of the oxidizing agent and/or water or solution or combination of solution composition. Here, in various embodiments, the above equations indicate that molecular hydrogen is formed in a one-step mechanism via trioxygen decomposition of the water molecule driven by the trioxygen dose generated in the solution. Alternatively, in various embodiments, the hydrogen atoms formed recombine to form molecular hydrogen. The detection of hydrogen atoms during the trioxygen exposure of the oxidizing agent, water, solution or combination of solution composition phase is a direct proof that the reactions take place. Likewise, the observation of oxygen atoms during the trioxygen exposure suggests that the reactions are also an important pathway of oxygen production. In various embodiments, the combination of photon Augmented Oxidizing Agent and substances to be treated stores hydrogen as hydronium or other isotopes of hydrogen and as suspended “bubbles” of hydrogen even when the exogenous photon exposure is terminated and trioxygen has ceased to be produced by placing the PAOA in a sealed container so that the suspended gases are not allowed to escape. Pressure that builds of the generated gases, in addition to the endogenous x-ray photons, maintains the reactivity and this potential can be stored for future use.

According to various embodiments, hydroxyl radicals (OH) are formed via a decomposition of a water molecule upon exposure to trioxygen. This trioxygen aided, self-sustaining circuit of reactions generates hydrogen and its ions, oxygen and its ions, x-ray photons, beta particles, hydrons and free radicals, as well as oxidizing molecules including, but not limited to, electronically modified oxygen derivatives, from water or solutions containing oxidizing agents that are exposed to photon emissions which when introduced to an effective amount of a composition containing water and/or an oxidizing agent compound or other compounds or solutions. The photon AOA when combined with a target compound to be treated contains generated trioxygen, where the composition including the water and/or oxidizing agent compound, solution, or both functions together with trioxygen to lead to a reaction producing hydrogen and its ions, oxygen and its ions, electronically modified oxygen derivatives, beta particles, hydron, endogenous x-ray photons and/or solutions derived or indirectly derived. These result from the exposure of the exogenous and endogenous photon emission wavelength(s) in the self-sustaining circuit of reactions. The resultant trioxygen along with generated endogenous x-ray photons and generated beta particles used in the self-sustained circuit of reactions function in the created synergistic reaction. Also, in various embodiments there is a decomposition of the HO₂ radical to molecular oxygen plus atomic hydrogen. Finally, to generate the HO₂ radical in various embodiments, another reaction takes place consisting of hydrogen atoms reacting with molecular oxygen. With the application of the correct wavelengths of photon emissions to the oxidizing agent undergoing this reaction in the self-sustained circuit of reactions, the excited state of produced hydrogen atoms and the produced molecular oxygen and the generation of trioxygen, beta particles, hydron and endogenous x-ray photons is retarded or stopped by the discontinuance of the exogenous photon emissions and the release of the created gases and endogenous photons. In various embodiments, the excited state is preserved by sealing the reactants so that produced gases are maintained and endogenous x-ray photons are reflected back into the solution, and this allows for the reactive potential to be stored.

The present disclosure describes a significant reaction sequence that has not been previously known, appreciated, or understood. According to various embodiments, by exposing an oxidizing agent to certain doses of photon emissions, hydrogen is liberated from the reactions described in this disclosure. In various embodiments, hydroperoxyls and trioxygen are produced when wavelengths of photon emission that dissociate trioxygen are eliminated or reduced in intensity. In other embodiments, the methods described in this disclosure proceed when x-ray photons and beta particles and hydrons are generated and available to modulate the reaction as described. This reaction generates endogenous x-ray photons, hydrogen, oxygen, trioxygen, hydrons and other free radicals, as well as oxidizing molecules including but not limited to electronically modified oxygen derivatives.

According to various embodiments, oxidizing agents that are exposed to certain wavelengths of photon emissions or solutions containing oxidizing agents that are exposed to certain wavelengths of photon emissions functions together with the photon emissions of certain wavelength or wavelengths to lead to a reaction producing endogenous x-ray photons, beta particles, hydron, trioxygen, hydrogen and/or its ions, oxygen and/or its ions, electronically modified oxygen derivatives, and/or solutions derived or indirectly derived resulting from the exposure to photons of said wavelength(s) as described in this disclosure. The oxidizing potential of trioxygen is slightly less than the oxidizing potential of hydroxyl radicals, but it is greater than the oxidizing potential of hydrogen peroxide. While the commonly accepted lifetime of hydroxyl radicals is a few nanoseconds, trioxygen has been shown to maintain its reactivity for several hours. The ability of trioxygen to linger for an extended period aids the methods of this disclosure in creating a “stored” oxidizing effect. In various embodiments, the stored oxidizing effect is tapped to provide reactive oxygen species as needed and the stored oxidizing effect feeds the self-sustaining circuit of reactions so that reactive oxygen species are generated until one of the reactants is depleted.

Table 4 reflects testing that displays this stored oxidizing effect. When comparing the oxidizing agent control (oxidizing agent without exposure to photons between 0.01 nm through 845 nm) versus the photon enhanced oxidizing agent solution that has been exposed to photon emissions of 0.01 nm through 845 nm, (there is over a 5-log increase in efficacy with the photon enhanced oxidizing agent solution when compared to the control (see table 4). By employing the self-sustaining circuit of reactions, embodiments of the disclosure have increased the production of the electronically modified oxygen derivatives, ROS, hydrogen and its ions, oxygen and its ions, beta particles, hydrons, endogenous x-ray photons and other free radicals that are being continuously generated so that there are more available for use over an extended period of time due to the reactions described in this disclosure.

The above equations are exemplary and are non-limiting with respect to wavelengths, frequency, time of exposure to photon emissions, intensity of photon emissions, or total dose of photon emissions. According to various embodiments, by exposing the oxidizing agent or agents to photon emissions from 0.01 nm to 845 nm, a synergistic reaction occurs creating trioxygen and other electronically modified oxygen derivatives and disrupting the typical disassociation reaction of the oxidizing agent or agents. Chemicals such as oxidizing agents exist in a state of flux whereby, they disassociate and reassociate as self-ionization reactions occur.

When alterations of the dissociation reactions occur, new compounds or variations in compound concentrations occur. In various embodiments, these new compounds or variations in compound concentrations created in the photon emission generated synergistic reaction enable a known oxidizing agent to create reactions that have not been observed or reported previously. In various embodiments, by restricting the photon emissions applied to the oxidizing agent so that dissociation of trioxygen is reduced or eliminated, a reaction is produced that has previously not been appreciated or reported. This is shown by the photon emissions typically produced as having wavelengths that dissociate trioxygen when said photon emission is applied to oxidizing agents. Restricting the dissociation of trioxygen has produced reaction products that have not been described for this reaction previously or that have not been produced in quantities that are shown in the present disclosure. The effect of restricting trioxygen dissociation while utilizing the endogenous generated x-ray photons has created a self-sustaining circuit of reactions that has not been previously reported.

According to various embodiments of the methods, the reactants contain enzymes, stabilizers, or other substances that affect the overall reaction rate. Enzymes, stabilizers, and/or other substances can be destroyed or inactivated by temperature variations, pH shifts, and other means. Various embodiments of these techniques are employed to arrive at favorable reaction outcomes. It is understood that phosphoric acid (H₃PO₄) is generally added to commercially available oxidizing agent solutions such as hydrogen peroxide as a stabilizer to inhibit the decomposition of the oxidizing agent. Several types of reagents, such as H₃PO₃, uric acid, Na₂CO₃, KHCO₃, barbituric acid, hippuric acid, urea, and acetanilide, have also been reported to serve as stabilizers for oxidizing agents such as hydrogen peroxide. These stabilizers have been shown to have a catalyst effect on some of the described reactions and an inhibitory effect on other areas of the reactions, but the reaction may proceed with or without stabilizers present in oxidizing agents, as desired.

Various embodiments of the present disclosure have applications in many industries. By increasing the efficacy of oxidizing agents, common chemical reactions involving oxidizing agents are accomplished using less volume and/or a lower concentration of oxidizing agents. According to various embodiments, oxidizing agents are used to precipitate material out of solution. Increasing the efficacy of the oxidizing agent allows for this precipitation with less oxidizing agent and/or a lower concentration of oxidizing agent.

Oxidizing agents have antimicrobial properties. According to various embodiments, by increasing the antimicrobial efficacy with the methods described herein, concentrations of oxidizing agents utilized may be reduced while efficacy is maintained or increased. By utilizing various embodiments in a small micron antimicrobial dry fog photon enhanced oxidizing agent solution, an extremely low concentration of a photon enhanced hydrogen peroxide solution is deposited in ambient air through a HVAC system rendering the air almost microbe free in a matter of a few hours. According to various embodiments, by increasing the availability of ROS in the photon augmented oxidizing agent solution, applications of oxidizing agents in the semiconductor industry, paper industry, petrochemical industry, and other commercial applications are accomplished faster, more economically, and/or more environmentally responsibly. The uses of the embodiments described herein are numerous and widespread in diverse industries from oil and gas to health care and beyond.

The foregoing description and accompanying figures illustrate the principles, embodiments, and modes of operation of the present disclosure. However, the disclosure should not be construed as being limited to the embodiments discussed herein. Additional variations of the embodiments will be appreciated by those skilled in the art. Therefore, the various embodiments should be regarded as illustrative rather than restrictive. Accordingly, it should be appreciated that variations to the embodiments described herein can be made by those skilled in the art without departing from the scope of the disclosure as defined by the following claims.

According to various embodiments of the present disclosure, a method for enhancing the effectiveness of products generated from ionization reactions, photon-enhanced thermionic emission reactions, multi photon absorption reactions, photo-oxidation reactions, photocatalytic reactions, photochemical reactions, and/or a combination of these reactions is provided. The reactions contain one or more of oxidizing agents, reactive nitrogen species, hydrogen and/or its isotopes, oxygen and/or its isotopes, electronically modified oxygen derivatives, reactive oxygen species, trioxygen, beta particles, hydrons, trioxidane, and other free radicals. Various embodiments of the method include: applying at least one oxidizing agent to a target, a substance, or an area to be treated; applying photon emissions at one or more wavelength in a range of from 0.01 nm to 845 nm to the oxidizing agent, the target, the substance, and or the area to be treated, wherein wavelengths that photo-dissociate trioxygen are excluded; and performing an oxidizing reaction between the at least one photon augmented oxidizing agent and the target, substance, and/or area to be treated, which produces the ionization reaction products, photo-oxidation reaction products, photocatalytic reaction products, and/or photochemical, or a combination of these reaction products, wherein the ionization reaction products, photon-enhanced thermionic emission reaction products, multi photon absorption reaction products, photo oxidation reaction products, photocatalytic reaction products, photochemical reaction products, and/or combination of reaction products generate at least one of trioxygen, hydrogen and its ions, oxygen and its ions, hydroxyl radicals, reactive oxygen species, free radicals, x-ray photons, beta particles, hydrons, trioxidane, free electrons, and electronically modified oxygen derivatives

In various embodiments of the method, the excluded wavelengths that dissociate trioxygen are one or more of 197 nm - 198 nm, 263 nm - 264 nm, 307 nm - 308 nm, 402 nm - 403 nm, 452 nm - 453 nm, 599 nm - 600 nm, and 1118 nm - 1119 nm.

In various embodiments of the methods displayed in this disclosure, the photon emissions are applied by an emission source selected from an x-ray generator, electromagnetic radiation emitting bulb, a light emitting diode, a laser or any other suitable means of generating photons of the required wavelength or wavelengths.

In various embodiments of the method, the photon emissions are applied directly or indirectly to the oxidizing agent, the target, the substance, and/or the area to be treated.

In various embodiments of the methods, the at least one oxidizing agent is applied to the target,r the substance, and/or the area to be treated with an oxidizing agent dispenser selected from a pump, mister, fogger, atomizer, diffuser, electrostatic sprayer, or other suitable device that dispenses the oxidizing agent in a desired particle size.

Various embodiments of the method further include applying additional reactants at various stages to aid the oxidizing reaction, wherein the additional reactants are selected from enzymes, catalysts, stabilizers, ions, photons, beta particles, hydrons, reactive oxygen species, flocculants, or other suitable agents.

In various embodiments of the method, the reaction product is used to precipitate and/or agglomerate material out of a liquid, plasma, air, or gas. In various embodiments of the method, the reaction product is an antimicrobial agent. In various embodiments of the method, the reaction product is a bleaching agent. In various embodiments of the method, at least one of photon-enhanced thermionic emission products and multi photon absorption products are generated. In various embodiments of the method, the reaction product is a catalyst, reactant, or other substance providing hydroxyl radicals, trioxane, hydrogen and or its ions, oxygen and or its ions, beta particles, hydrons, EMODS, free electrons, free radicals, or other reactive oxygen species.

In various embodiments of the method, the photon emissions are applied as a single wavelength or multiple wavelengths, applied either independently or simultaneously, and/or applied either continuously or pulsed. In various embodiments of the method, the photon emissions are at an emission dose that is varied or not varied.

In various embodiments of the method, the viscosity of the target is adjusted to aid the reactions.

In various embodiments of the method, the amount of the at least one oxidizing agent is in a range from less than 1 part per million to 50 percent of the volume of the target. the substance, and/or area to be treated.

In various embodiments of the method, the photon emissions are applied to the at least one oxidizing agent before and/or while the at least one oxidizing agent is applied to the target, the substance and/or the area to be treated, the target, the substance, and/or area to be treated furthers the oxidization reaction, the oxidation reaction, and/or produces one or more additional reaction, and the further or one or more additional reactions are not dependent on continued or additional application of the exogenous photon emissions.

In various embodiments of the method, the photon emissions are applied to the at least one oxidizing agent after the at least one oxidizing agent is applied to the target, substance, and/or area to be treated so that trioxygen, endogenous x-ray photons, hydrons, beta particles, hydrogen and its ions, oxygen and its ions, trioxidane, and other reaction products are generated after the at least one oxidizing agent is applied to the target, substance, and/or area to be treated, and the oxidization reaction and/or oxidation reaction is readied but not initiated until a preset time or event.

In various embodiments of the method, the oxidation reaction occurs in a sealed container whereby gases created by the ionization and/or oxidation reaction are not allowed to escape. In various embodiments, the generated endogenous x-ray photons are reflected or scattered so that they are available to further ionized reactants, thereby creating a self-sustaining circuit or reactions.

In various embodiments of this disclosure, x-ray photon reflective containers or areas are utilized to reflect the endogenous generated x-ray photons back into the reactants, oxidizing agents, targets, substances, or areas to be treated.

In various embodiments of the method, the at least one oxidizing agent is selected from oxygen (O₂), trioxygen (O₃), hydrogen (H), hydrogen peroxide (H₂O₂), inorganic peroxides, Fenton’s reagent, fluorine (F₂), chlorine (Cl₂), halogens, nitric acid (HNO₃), nitrate compounds, sulfuric acid (H₂SO₄), peroxydisulfuric acid (H₂S₂O₈), peroxymonosulfuric acid (H₂SO₅), sulfur compounds, hypochlorite, chlorite, chlorate, perchlorate, other analogous halogen compounds, chromic acid, dichromic acid, calcium oxide, chromium trioxide, pyridinium chlorochromate (PCC), chromate, dichromate compounds, hexavalent chromium compounds, potassium permanganate (KMnO4), sodium perborate, permanganate compounds, nitrous oxide (N₂O), nitrogen dioxide/dinitrogen tetroxide (NO₂/N₂O₄), urea, potassium nitrate (KNO₃), sodium bismuthate (NaBiO₃), ceric ammonium nitrate, ceric sulfate, cerium (IV) compounds, peracetic acid, and lead dioxide (PbO₂). This list is not to be inclusive of all oxidizing agents but is meant to serve as examples of oxidizing agents.

Various embodiments of the method further include determining the formulation of the at least one oxidizing agent, wherein the formulation is based on one or more properties of whether the target, and/or substance, and/or area to be treated is under aerobic or anaerobic conditions, pH of the target, substance, and/or area to be treated, temperature of the target, substance, and/or area to be treated, salinity of the target, substance, and/or area to be treated, consortium or population characteristics of organisms or micro-organism present, content of the target, substance, and/or area to be treated, or content of any biofilms associated with the target, substance, and/or area to be treated .

In various embodiments of the method, the at least one oxidizing agent further includes at least one other substance that aids in a desired process when applied to the target, substance, and/or area to be treated, the desired process selected from antimicrobial properties, anti-corrosion properties, bleaching properties, blood rendering properties, anti-neoplastic properties, thermal properties, explosive properties, precipitation properties, electrochemical properties, power generation properties, or any other applicable applications of the methods displayed in this disclosure.

In various embodiments of the methods, at least one of the photon emission wavelengths, frequency intensity, frequency duration, or location relative to the target, substance, and/or area to be treated is determined on the basis of any one or more of: the density and radiation absorbing, reflection, or scattering quality of the target, substance, and/or area to be treated; the size, shape, or composition of a container containing the target, substance, and/or area to be treated; conditions or properties of the environment of the target, substance, and/or area to be treated; whether the target, substance, and/or area to be treated is under aerobic or anaerobic conditions; pH, temperature, salinity of the target, substance, and/or area to be treated; consortium or population characteristics of any organisms or microorganisms present in the target, substance, and/or area to be treated; microbial content of the target, substance, and/or area to be treated; and microbial content of any biofilm present in the target and/or substance or area to be treated; or a container containing the target, substance, and/or area to be treated.

In various embodiments of the method, the concentration, temperature, viscosity, and/or pH of the at least one oxidizing agent is adjusted to produce a desired reaction or results.

In various embodiments of the method, the at least one oxidizing agent, target, substance, and/or area to be treated is a liquid, solid, gas, plasma, or combination thereof, either independently or simultaneously.

In various embodiments of the method, the oxidation reaction is affected or initiated by an addition of other catalysts. In embodiments, the catalyst is endogenous photon emissions of from 0.1 nm to 845 nm.

In various embodiments of the method, the duration of the photon emissions is in a range from 1 second or less to 30 minutes or more, the emissions continuous, pulsed, or intermittent.

In various embodiments of the method, the at least one oxidizing agent, target, substance, and/or to be treated is heated or cooled to activate and/or inactivate enzymes present in the target, substance, and/or area to be treated.

In various embodiments of the method, the pH of the oxidizing agent, target, substance, and/or area to be treated is optimized to aid in the formation of a desired reactive oxygen species. In various embodiments, the pH of the oxidizing agent, target, substance, and/or area to be treated is optimized to aid in elimination or reduction in activity of selected reactive oxygen species.

According to various embodiments of the present disclosure, a system is configured to perform a method for enhancing the effectiveness of products generated from ionization reactions, photon-enhanced thermionic reactions, multi photon absorption reactions, photo-oxidation reactions, photocatalytic reactions, photochemical reactions, and/or a combination of these reactions. The reactions include one or more of oxidizing agents, reactive nitrogen species, hydrogen and/or its isotopes, oxygen and/or its isotopes, electronically modified oxygen derivatives, reactive oxygen species, trioxygen, beta particles, hydrons, trioxidane, and other free radicals. The system includes: a reaction area, in which the at least one oxidizing agent functions together with photon emissions to perform the ionization reaction and/or oxidation reaction, so that products of the ionization reaction and/or oxidation reaction can be collected and separated at any time during the reaction seqeunce; at least one oxidizing agent introducing component for applying the at least one oxidizing agent to the target, substance, and/or area to be treated; and at least one photon emitting component for creating and dispensing the photon emissions.

Various embodiments of the system further include one or more sensors or other devices to indicate, detect, or inform of one or more of the following properties of the reactants, target or storage or environment: pH, photon emissions, temperature, salinity, x-ray radiation, gamma radiation, pressure, oxidation and reduction potential, density, trioxygen concentration, oxygen and its ions concentration, oxidizing agent concentration, hydron concentration, gamma ray concentration, beta particle concentration, hydrogen and its ions concentration, oxidizing agent concentration, flow rate, microbial content, presence or absence of bacterial species, presence or absence of corrosive metabolites or otherwise corrosive substance, identification of a gas, presence or absence of an aqueous environment, presence or absence of high, low, or otherwise concentration of bacteria or non-bacteria, biomass or non-biomass, or microbial content, and location of biofilms.

In various embodiments of the system, the at least one photon emitting component emits, delivers, produces, or otherwise facilitates photon emissions in a range from 0.01 nanometers to 845 nanometers, independently, simultaneous, continuously, or intermittently. In various embodiments, the at least one photon emitting component is suspended, adjacent to, inside of, surrounding, or associated with a container, structure, area of the at least one oxidizing agent, the target, substance, and/or area to be treated, and/or supported in a target container In various embodiments, the at least one photon emitting component is or is not physically close to the at least one oxidizing agent, the target, and/or the substance or area to be treated.

In various embodiments of the system, the at least one photon emitting component adjusts one or more of the photon emission wavelengths, frequency, intensity, duration, or location relative to the target, substance, and/or area to be treated on the basis of any one or more of the density, light absorbing, reflection, or scattering quality of the target, substance, and/or area to be treated, the size, shape, or composition of the reaction area, conditions or properties of the environment, whether the target, substance, and/or area to be treated is under aerobic or anaerobic conditions, pH, temperature, or salinity of the target, substance, and/or area to be treated, consortium or population characteristics of any organisms or micro-organisms present in the target, substance, and/or area to be treated, microbial content of the target, substance, and/or area to be treated, and the microbial content of any biofilm present in the target, substance, and/or area to be treated.

### EXAMPLE

This study was performed to determine the survival rate of various organisms when exposed to photon augmented oxidizing agents (PAOA) as described by embodiments of the present disclosure. The test employed methods designed to determine antimicrobial effectiveness described in the United States Pharmacopeia.

Inoculum Control Results

| | |
|---|---|
| ORGANISM | CHALLENGE TITER AT O HOUR(CFU / ml) |
| E. coli | 2.5 × 10⁵ |

Inoculum Test Results

| SAMPLE NAME | TIME INTERVAL AND MICROBIAL REDUCTION | | | |
|---|---|---|---|---|
| | 48 Hours | 7 Days | 14 Days | Comments |
| 8 | N=6 | >4.14 log reduction | >4.14 log reduction | |
| 10 | N=20 | >4.14 log reduction | >4.14 log reduction | |
| 3 | N=85 | >4.14 log reduction | >4.14 log reduction | |
| 12 | N= 66 | >4.14 log reduction | >4.14 log reduction | |
| 15 | N=53 | >4.14 log reduction | >4.14log reduction | |
| 18 | N=74 | >4.14 log reduction | >4.14 log reduction | |
| 25 | N=96 | >4.14 log reduction | >4.14 log reduction | |
| 395 | N=120 | >4.14 log reduction | >4.14 log reduction | |
| 01/11/21--2 | N=31 | >4.14 log reduction | >4.14 log reduction | |
| 01/11/21--10 | N=91 | >4.14 log | >4.14 log | |
| | | reduction | reduction | |

What is claimed is:

1. A method for enhancing effectiveness of products generated from ionization reactions, photon-enhanced thermionic emission reactions, multi photon absorption reactions, photo-oxidation reactions, photocatalytic reactions, photochemical reactions, and/or a combination of these reactions, the reactions comprising one or more of oxidizing agents, reactive nitrogen species, hydrogen and/or its isotopes, oxygen and/or its isotopes, electronically modified oxygen derivatives, reactive oxygen species, trioxygen, beta particles, hydrons, trioxidane, and other free radicals, the method comprising:
applying at least one oxidizing agent to a target, a substance, or an area to be treated;
applying photon emissions at one or more wavelengths in a range from 0.01 nm to 845 nm to the oxidizing agent, the target, the substance, and/or the area to be treated, wherein wavelengths that photo-dissociate trioxygen are excluded; and
performing an oxidizing reaction between the at least one photon augmented oxidizing agent and the target, the substance, and/or the area to be treated, which produces the ionization reaction products, photon-enhanced thermionic emission reaction products, multi photon absorption reaction products, photo-oxidation reaction products, photocatalytic reaction products, photochemical reaction products, and/or a combination of the reaction products thereof,
wherein the ionization reaction products, photon-enhanced thermionic emission reaction products, multi photon absorption reaction products, photo oxidation reaction products, photocatalytic reaction products, photochemical reaction products, and/or combination of the reaction products thereof generate at least one of trioxygen, hydrogen and its ions, oxygen and its ions, hydroxyl radical, reactive oxygen species, free radicals, x-ray photons, beta particles, hydrons, trioxidane, free electrons, and electronically modified oxygen derivatives.

2. The method of claim 1, wherein the excluded wavelengths that dissociate trioxygen are selected from the group consisting of: 197 nm - 198 nm, 263 nm - 264 nm, 307 nm - 308 nm, 402 nm - 403 nm, 452 nm - 453 nm, 599 nm - 600 nm, and 1118 nm - 1119 nm.

3. The method of claim 1, wherein the photon emissions are applied by an emission source selected from the group consisting of an x-ray generator, electromagnetic radiation emitting bulb, Light Emitting Diode, and laser.

4. The method of claim 1, wherein the photon emissions are applied directly or indirectly to the oxidizing agent, the target, the substance, and/or the area to be treated.

5. The method of claim 1, wherein the at least one oxidizing agent is applied to the target, the substance, and/or the area to be treated with an oxidizing agent dispenser selected from the group consisting of a pump, mister, fogger, atomizer, diffuser, and electrostatic sprayer.

6. The method of claim 1, further comprising applying additional reactants at various stages to aid the oxidizing reaction, wherein the additional reactants are selected from the group consisting of enzymes, catalysts, stabilizers, ions, photons, beta particles, hydrons, reactive oxygen species, and flocculants.

7. The method of claim 1, wherein the reaction products are used to precipitate and/or agglomerate material out of a liquid, plasma, air, or gas.

8. The method of claim 1, wherein the reaction products are antimicrobial agents and/or bleaching agents.

9. The method of claim 1, wherein at least one of photon-enhanced thermionic emission products and multi photon absorption products are generated.

10. The method of claim 1, wherein the reaction products are a catalyst, a reactant, or a substance providing hydroxyl radicals, trioxidane, hydrogen and its ions, oxygen and its ions, electronically modified oxygen derivatives, beta particles, hydrons, free radicals, or reactive oxygen species.

11. The method of claim 1, wherein the photon emissions are applied as a single wavelength or multiple wavelengths, applied either independently or simultaneously, applied either continuously or pulsed, and applied at an emission dose that is varied or not varied.

12. The method of claim 1, wherein the viscosity of the target is adjusted to aid the reactions.

13. The method of claim 1, wherein the amount of the at least one oxidizing agent is in a range from less than 1 part per million to 50 percent or more of the volume of the target, the substance and/or the area to be treated.

14. The method of claim 1, wherein the photon emissions are applied to the at least one oxidizing agent before and/or while the at least one oxidizing agent is applied to the target, the substance, and/or the area to be treated,
the target, the substance, and/or the area to be treated furthers the ionization reactions, the oxidization reactions, and/or produces one or more additional reactions, and
the one or more additional reactions are not dependent on continued or additional application of the photon emissions.

15. The method of claim 1, wherein the photon emissions are applied to the at least one oxidizing agent after the at least one oxidizing agent is applied to the target, the substance, and/or the area to be treated so that the trioxygen, endogenous x-ray photons, hydrons, beta particles, hydrogen and its ions, oxygen and its ions, trioxidane, and other reaction products are generated after the at least one oxidizing agent is applied to the target, the substance, and/or the area to be treated, and the ionization reaction and/or oxidization reaction is readied but not initiated until a preset time or event.

16. The method of claim 1, wherein the oxidation reaction occurs in a sealed container, gases created by the ionization reaction and/or oxidation reaction are not allowed to escape, and generated endogenous x-ray photons are reflected or scattered so that they are available to further ionize reactants, thereby creating a self-sustaining circuit of reactions.

17. The method of claim 1, wherein the at least one oxidizing agent is selected from the group consisting of oxygen (O₂), trioxygen (O₃), hydrogen (H), hydrogen peroxide (H₂O₂), inorganic peroxides, Fenton’s reagent, fluorine (F₂), chlorine (Cl₂), halogens, nitric acid (HNO₃), nitrate compounds, sulfuric acid (H₂SO₄), peroxydisulfuric acid (H₂S₂O₈), peroxymonosulfuric acid (H₂SO₅), sulfur compounds, hypochlorite, chlorite, chlorate, perchlorate, other analogous halogen compounds, chromic acid, dichromic acid, calcium oxide, chromium trioxide, pyridinium chlorochromate (PCC), chromate, dichromate compounds, hexavalent chromium compounds, potassium permanganate (KMnO4), sodium perborate, permanganate compounds, nitrous oxide (N₂O), nitrogen dioxide/dinitrogen tetroxide (NO₂/N₂O₄), urea, potassium nitrate (KNO₃), sodium bismuthate (NaBiO₃), ceric ammonium nitrate, ceric sulfate, cerium (IV) compounds, peracetic acid, and lead dioxide (PbO₂) and any other oxidizing agent or oxidizing agents.

18. The method of claim 1, further comprising determining the formulation of the at least one oxidizing agent, wherein the formulation is based on one or more properties of whether the target, the substance, and/or the area to be treated is under aerobic or anaerobic conditions, pH of the target, the substance, and/or the area to be treated, temperature of the target, the substance, and/or the area to be treated, salinity of the target, the substance, and/or the area to be treated, consortium or population characteristics of organisms or micro-organism present, content of the target, the substance, and/or the area to be treated, or content of any biofilms associated with the target, the substance, and/or the area to be treated .

19. The method of claim 1, wherein the at least one oxidizing agent further comprises at least one other substance that aids in a desired process when applied to the target, the substance, and/or the area to be treated, the desired process selected from the group consisting of antimicrobial properties, anti-corrosion properties, bleaching properties, blood rendering properties, anti-neoplastic properties, thermal properties, explosive properties, precipitation properties, electrochemical properties, and power generation properties.

20. The method of claim 1, wherein at least one of the photon emission wavelength, frequency, intensity, duration, or location relative to the target, the substance and/or the area to be treated is determined on the basis of any one or more of: the density and radiation absorbing, scattering or reflection quality of the target, the substance, and/or the area to be treated; the size, shape, or composition of a container containing the target, the substance, and/or the area to be treated; conditions or properties of the environment of the target, the substance, and/or the area to be treated; whether the target, the substance, and/or the area to be treated is under aerobic or anaerobic conditions; pH, temperature, salinity of the target, the substance, and/or the area to be treated; consortium or population characteristics of any organisms or microorganisms present in the target, the substance, and/or the area to be treated; microbial content of the target, the substance, and/or the area to be treated; microbial content of any biofilm present in the target, the substance, and/or the area to be treated; or a container containing the target, the substance, and/or the area to be treated.

21. A system configured to perform the method of claim 1, comprising:
a reaction area, in which the at least one oxidizing agent functions together with photon emissions to perform the ionization reaction and/or the oxidation reaction, so that products of the ionization reaction and/or oxidation reaction can be collected and separated at any time during the reaction sequences;
at least one oxidizing agent introducing component for applying the at least one oxidizing agent to the target, the substance, and/or the area to be treated; and
at least one photon emission emitting component for creating and dispensing the photon emissions.

22. The system of claim 21, further comprising one or more sensors or other devices to indicate, detect, or inform of one or more of the following properties of the target or storage or environment: pH, photon emissions, pressure, temperature, salinity, density, trioxygen concentration, oxygen and its ions concentration, hydrogen and its ions concentration, hydron concentration, oxidizing agent concentration, flow rate, microbial content, presence or absence of bacterial species, presence or absence of corrosive metabolites or otherwise corrosive substance, identification of a gas, presence or absence of an aqueous environment, presence or absence of high, low, or otherwise concentration of bacteria or non-bacteria, biomass or non-biomass, or microbial content, and location of biofilms.

23. The system of claim 21, further comprising at least one photon emitting component,
wherein the at least one photon emitting component emits, delivers, produces, or otherwise facilitates photon emissions from 0.01 nanometers to 845 nanometers independently, simultaneous, continuously, or intermittently,
wherein the at least one photon emitting component is suspended, adjacent to, inside of, surrounding, or associated with a container, structure, area of the at least one oxidizing agent, the target, substance, and/or the area to be treated, and/or supported in a target container, and
wherein the at least one photon emitting component is or is not physically close to the at least one oxidizing agent, the target, the substance, and/or area to be treated.

24. The system of claim 23, wherein the at least one photon emitting component adjusts one or more of: the photon emission wavelengths, frequency, intensity, duration, or location relative to the target, the substance, and/or the area to be treated on the basis of one or more of density, light absorbing, scattering, or reflection quality of the target, the substance, and/or the area to be treated; the size, shape, or composition of the reaction area; conditions or properties of the environment; whether the target, the substance, and/or the area to be treated is under aerobic or anaerobic conditions; pH, temperature, or salinity of the target, the substance, and/or the area to be treated; consortium or population characteristics of any organisms or micro-organisms present in the target, the substance, and/or the area to be treated; microbial content of the target, the substance, and/or the area to be treated; microbial content of any biofilm present in the target, the substance, and/or the area to be treated; the reaction area; or the environment.

25. The method of claim 1, wherein concentration, temperature, viscosity, and/or pH of the at least one oxidizing agent are adjusted to produce a desired reaction or results.

26. The method of claim 1, wherein the at least one oxidizing agent and the target, the substance, and/or the area to be treated is a liquid, solid, gas, plasma, or combination thereof, either independently or simultaneously.

27. The method of claim 1, wherein the oxidation reaction is affected or initiated by the addition of other catalysts including exogenous and/or endogenous photon emissions of from 0.01 nm through 845 nm.

28. The method of claim 1, wherein the duration of the photon emissions is in a range from less than 1 second to 30 minutes, the photon emissions continuous, pulsed, or intermittent.

29. The method of claim 1, wherein the at least one oxidizing agent, target, the substance, and/or the area to be treated is heated or cooled to activate and/or inactivate enzymes present in the target, the substance, and/or the area to be treated.

30. The method of claim 1, wherein the pH of the oxidizing agent, target, the substance and/or the area to be treated is optimized to aid in formation of a desired reactive oxygen species, and/or wherein the pH of the oxidizing agent, target, the substance, and/or the area to be treated is optimized to aid in elimination or reduction in activity of selected reactive oxygen species.
